(19) United States
(12) Patent Application Publication
(10) Pub. No.: US 2018/0095576 A1
(43) Pub. Date: Apr. 5, 2018

(54) DISPLAY DEVICE AND METHOD

(71) Applicant: Japan Display Inc., Tokyo (JP)

(72) Inventors: Nobuhiko Yokoo, Tokyo (JP); Jin Ota, Tokyo (JP); Hidetoshi Komatsu, Tokyo (JP)

(21) Appl. No.: 15/725,201

(22) Filed: Oct. 4, 2017

(30) Foreign Application Priority Data
Oct. 4, 2016 (JP) 2016-196511

(51) Int. Cl. G06F 3/041; G09G 3/36; G02F 1/1333; G06F 3/044; G02F 1/1343

(52) U.S. Cl. CPC G06F 3/0412; G09G 3/3655; G09G 3/3614; G02F 1/13338; G06F 3/044; G02F 2001/134372; G09G 2310/08; G06F 2203/04112; G09G 2300/0426; G02F 2201/121; G02F 1/134309

(57) ABSTRACT

According to one embodiment, a display device driven in a first drive mode for displaying images of a frame in a first frame period and a second drive mode for displaying images of a frame in a second frame period longer than the first frame period is provided. The display device includes a display panel configured to perform display operation for displaying an image based on a pixel signal and a driver configured to switch a drive mode between the first drive mode and the second drive mode. When a switch signal is received while the display device is driven in the second drive mode, the driver is configured to shorten the second frame period and switch the second drive mode to the first drive mode.

### CROSS-REFERENCE TO RELATED APPLICATIONS

This application is based upon and claims the benefit of priority from Japanese Patent Application No. 2016-196511, filed Oct. 4, 2016, the entire contents of which are incorporated herein by reference.

### FIELD

Embodiments described herein relate generally to a display device and a method.

### BACKGROUND

In recent years, various types of display devices such as liquid crystal display devices and organic electroluminescent (EL) display devices have been known. In these display devices, by rewriting the images (screen) of one frame at a predetermined refresh rate (frame rate), for example, the images (moving image) can be displayed.

The display devices may be driven at low speed by decreasing the refresh rate of images of normal driving. In low-speed driving, the power consumption of the display devices can be reduced.

To reduce power consumption, it is effective to change the drive state (drive mode) of the display devices to low-speed driving. For example, to avoid a delay in displaying (rewriting) images, the display devices are required to promptly return from low-speed driving to normal driving in the drive state depending on the need. It is important to appropriately switch the drive state of the display devices.

### BRIEF DESCRIPTION OF THE DRAWINGS

FIG. 1 is a perspective view showing an example of the outline structure of a display device according to a first embodiment.

FIG. 2 mainly shows an example of the outline structure of a display panel provided in the display device.

FIG. 3 schematically shows an example of the cross-sectional structure of the display device.

FIG. 4 is shown for explaining the basic operation of a touch detection mechanism.

FIG. 5 is shown for explaining the relationship between common electrodes and touch detection electrodes.

FIG. 6 is shown for explaining the relationship between display periods and touch detection periods.

FIG. 7 mainly shows an example of the circuit structure inside a panel driver.

FIG. 8 is shown for explaining the arrangement of display periods, touch detection periods and display adjustment periods in each frame period in a normal drive mode.

FIG. 9 is shown for explaining the arrangement of display periods, touch detection periods and display adjustment periods in each frame period in a low-speed drive mode.

FIG. 10 shows an example of the configuration of a timing controller provided in the panel driver.

FIG. 11 is a flowchart shown for explaining the outline of the operation of the timing controller.

FIG. 12 is shown for explaining the transition of frame periods when no RAMWR command is received in the low-speed drive mode.

FIG. 13 is shown for explaining the transition of frame periods when a RAMWR command is received in the low-speed drive mode.

FIG. 14 is shown for explaining the transition of frame periods when a RAMWR command is received in the low-speed drive mode.

FIG. 15 is a timing chart showing the relationship of various signals in each frame period in the normal drive mode.

FIG. 16 is a timing chart showing the relationship of various signals in each frame period in the low-speed drive mode.

FIG. 17 is a timing chart showing the relationship of various signals when touch detection operation is performed in each perpendicular front porch period.

FIG. 18 is shown for explaining the transition of frame periods according to a first modification.

FIG. 19 is shown for explaining the transition of frame periods according to the first modification.

FIG. 20 is shown for explaining the transition of frame periods according to a second modification.

FIG. 21 is shown for explaining the transition of frame periods according to the second modification.

FIG. 22 is shown for explaining the transition of frame periods when the first modification is combined with the second modification.

FIG. 23 is shown for explaining the transition of frame periods when the first modification is combined with the second modification.

FIG. 24 schematically shows an example of the cross-sectional structure of a display device according to a second embodiment.

FIG. 25 is a timing chart showing the relationship of various signals in each frame period in a normal drive mode.

FIG. 26 is a timing chart showing the relationship of various signals in each frame period in a low-speed drive mode.

### DETAILED DESCRIPTION

Embodiments will be described hereinafter with reference to the accompanying drawings.

According to one embodiment, a display device driven in a first drive mode for displaying images of a frame in a first frame period and a second drive mode for displaying images of a frame in a second frame period longer than the first frame period is provided. The display device includes a display panel and a driver. The display panel is configured to perform display operation for displaying an image based on a pixel signal. The driver is configured to switch a drive mode between the first drive mode and the second drive mode by controlling the display operation. When a switch signal for switching the second drive mode to the first drive mode is received while the display device is driven in the second drive mode, the driver is configured to shorten the second frame period and switch the second drive mode to the first drive mode.

### First Embodiment

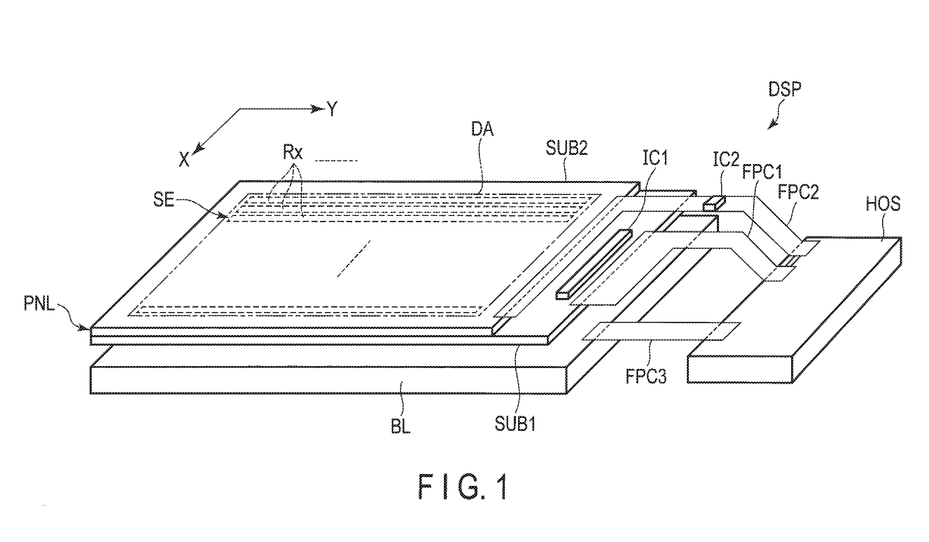

A first embodiment is explained. FIG. 1 is a perspective view showing the outline structure of a display device DSP according to the present embodiment. In the present embodiment, the display device DSP is explained as a display device having a touch detection function. The display device having a touch detection function may be a display device having an on-cell touch detection mechanism or a display device having an in-cell touch detection mechanism. In an on-cell touch detection mechanism, a touchpanel is formed on the display surface of the display device. In an in-cell touch detection mechanism, a common electrode originally provided in the display device for image display is used as one of a pair of touch detection electrodes, and the other touch detection electrode is provided so as to intersect the common electrode. In the following description, the display device DSP of the present embodiment is explained as a display device having an in-cell touch detection mechanism.

As shown in FIG. 1, the display device DSP includes a display panel PNL. The display panel PNL is a display panel integrally including a touch detection mechanism. For the display panel PNL, for example, a display panel using a liquid crystal layer as a display function layer or an organic electroluminescent (EL) panel using an organic light-emitting layer is used. Here, a display panel using a liquid crystal layer is explained.

In the present embodiment, touch detection includes detection of contact of an object such as a finger (or a stylus) on the display panel PNL and, for example, detection of adjacency of an object to the display panel PNL.

The display panel PNL includes a first substrate SUB1 (array substrate), a second substrate SUB2 (counter-substrate) facing the first substrate SUB1, and a liquid crystal layer (not shown) formed between the first substrate SUB1 and the second substrate SUB2. For example, on the first substrate SUB1, a panel driver (liquid crystal driver) IC1 which drives the display panel PNL is mounted.

The display panel PNL is integrated with, for example, a touch detection mechanism SE (detector) of a capacitive change detection type. In FIG. 1, touch detection electrodes Rx forming the touch detection mechanism SE are provided on the surface of the display area DA of the display panel PNL. Each touch detection electrode Rx is, for example, a transparent electrode, and is formed of indium tin oxide (ITO), etc. The touch detection electrodes Rx may be provided either outside or inside the display panel PNL. The touch detection mechanism SE is controlled by a touch driver IC2.

A host device HOS is provided outside the display device DSP. The host device HOS is connected to the display panel PNL via a flexible wiring board FPC1 and the panel driver IC1. The host device HOS is connected to the touch detection mechanism SE via a flexible wiring board FPC2 and the touch driver IC2.

The panel driver IC1 and the touch driver IC2 may be structured as the same chip. When the touch driver IC2 and the panel driver IC1 are structured as the same chip, one of flexible wiring boards FPC1 and FPC2 may be omitted by providing the chip on, for example, the second substrate SUB2, flexible wiring board FPC1 or flexible wiring board FPC2.

A backlight unit BL is provided on the lower side of the first substrate SUB1 (in other words, the rear side of the display panel PNL) as a lighting device which illuminates the display panel PNL. A flexible wiring board FPC3 connects the backlight unit BL and the host device HOS. Various forms may be applied to the backlight unit BL. As the light source, for example, a light-emitting diode (LED) or a cold-cathode fluorescent lamp (CCFL) is considered. In this explanation, the backlight unit BL provided on the rear side of the display panel PNL is used. However, a front light provided on the display side of the display panel PNL may be used. A lighting device using a lightguide plate and an LED or CCFL provided on a side of the lightguide plate may be used. Alternatively, a lighting device using a dot-like light source in which light-emitting elements are planarly arranged may be used. When the display device DSP is a reflective type display device, or when the display panel PNL uses an organic electroluminescent display, a lighting device may not be provided.

Although omitted in FIG. 1, the display device DSP includes a secondary battery, a power supply circuit, etc.

The display panel PNL of the present embodiment may be a transmissive type, reflective type or transflective type display panel PNL. When a transmissive type display panel PNL is applied to the display device DSP, the display device DSP includes, as described above, the backlight unit BL on the rear side of the first substrate SUB1, and has a transmissive display function which displays an image by selectively transmitting the light emitted from the backlight unit BL. When a reflective type display panel PNL is applied to the display device DSP, the display device DSP includes a reflective layer which reflects light toward the rear side of the display panel PNL in comparison with the liquid crystal layer, and has a reflective display function which displays an image by selectively reflecting the light emitted from the front side (display side) of the second substrate SUB2. An auxiliary light source may be provided on the front side of the reflective type display panel PNL. The reflective layer may be formed of a material having a reflective function, such as metal, and be configured to form an electrode provided on the rear side of the display panel PNL in comparison with the liquid crystal layer. When a transflective type display panel PNL is applied to the display device DSP, the display device DSP has the above transmissive display function and the above reflective display function.

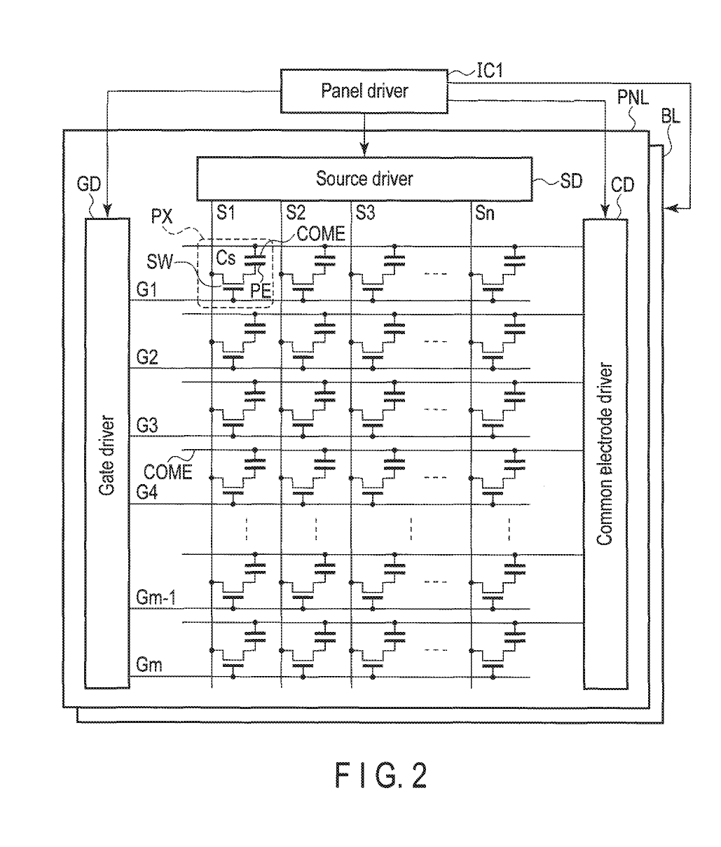

FIG. 2 mainly shows the outline structure of the display panel PNL provided in the display device DSP. As shown in FIG. 2, a plurality of display pixels PX (display elements) are arranged in matrix on the display panel PNL. Further, the display panel PNL includes scanning lines G (G1, G2, . . . , Gm) extending along the rows of the display pixels PX, signal lines S (S1, S2, . . . , Sn) extending along the columns of the display pixels PX, and pixel switches SW provided near the intersections of the scanning lines G and the signal lines S.

Each pixel switch SW includes a thin-film transistor (TFT). The gate electrode of each pixel switch SW is electrically connected to a corresponding scanning line G. The source electrode of each pixel switch SW is electrically connected to a corresponding signal line S. The drain electrode of each pixel switch SW is electrically connected to a corresponding pixel electrode PE. Alternatively, the source electrode of each pixel switch SW may be connected to a corresponding pixel electrode PE, and the drain electrode of each pixel switch SW may be connected to a corresponding signal line S.

A gate driver GD and a source driver SD are provided on the display panel PNL to drive the display pixels PX. The scanning lines G are electrically connected to the output terminals of the gate driver GD. The signal lines S are electrically connected to the output terminals of the source driver SD.

The gate driver GD sequentially applies on-voltage to a plurality of scanning lines G and applies on-voltage to the gate electrodes of the pixel switches SW electrically connected to the selected scanning lines G. When on-voltage is applied to the gate electrodes, the pixel switches SW are brought into conduction between the source electrodes and the drain electrodes.

The source driver SD supplies a corresponding output signal to each signal line S. The signal supplied to each signal line S is applied to corresponding pixel electrodes PE via the pixel switches SW brought into conduction between the source electrodes and the drain electrodes.

Further, the display panel PNL includes a common electrode driver CD. The common electrode driver CD is a circuit which supplies a drive signal (in other words, a circuit which applies drive voltage) to the common electrodes COME of the display device DSP. The common electrodes COME are explained later. The pixel electrodes PE and the common electrodes COME face each other via an insulating film. The pixel electrodes PE, the common electrodes COME and the insulating film form storage capacitance CS.

The gate driver GD, the source driver SD and the common electrode driver CD are provided in the peripheral region (frame) of the display panel PNL, and are controlled by the panel driver IC1. Further, the panel driver IC1 controls the operation of the backlight unit BL.

FIG. 2 shows only one gate driver GD. However, the display panel PNL may include a plurality of (for example, two) gate drivers GD. When two gate drivers are provided, for example, one of the gate drivers is connected to, of the plurality of scanning lines G, scanning lines G1, G3, . . . , Gm−1. The other gate driver is connected to scanning lines G2, G4, . . . , Gm. For example, the two gate drivers are provided so as to face each other across intervening display pixels PX.

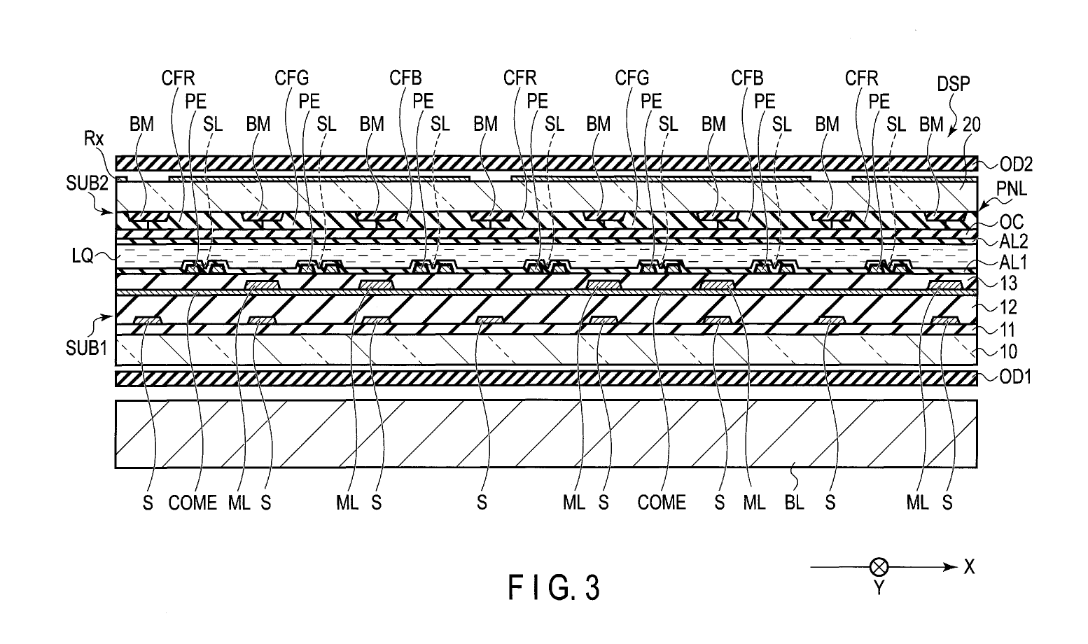

FIG. 3 is a drawing (cross-sectional view) schematically showing the cross-sectional structure of the display device DSP. The display device DSP includes the display panel PNL, the backlight unit BL, a first optical element OD1 and a second optical element OD2.

In FIG. 3, the display panel PNL includes a structure corresponding to a fringe-field switching (FFS) mode as a display mode. However, the display panel PNL may include a structure corresponding to another display mode.

As described above, the display panel PNL includes the first substrate SUB1, the second substrate SUB2 and the liquid crystal layer LQ. The first substrate SUB1 is attached to the second substrate SUB2 in a state where a predetermined cell gap is formed. The liquid crystal layer LQ is retained in the cell gap between the first substrate SUB1 and the second substrate SUB2. The first substrate SUB1 is formed by using a phototransmissive first insulating substrate 10 such as a glass or resinous substrate. The first substrate SUB1 includes, on the side of the first insulating substrate 10 facing the second substrate SUB2, the signal lines S, the common electrodes COME, the pixel electrodes PE, a first insulating film 11, a second insulating film 12, a third insulating film 13, a first alignment film AL1, etc.

The pixel electrodes PE and the common electrodes COME constitute the display pixels PX together with the pixel region of the liquid crystal layer LQ. The display pixels PX are arranged in matrix on the display panel PNL as explained with reference to FIG. 2.

The first insulating film 11 is provided on the first insulating substrate 10. The signal lines S are formed on the first insulating film 11. In the example shown in FIG. 3, the signal lines S extend in a Y-direction.

Although not shown in FIG. 3, for example, the scanning lines G and the gate electrodes and semiconductor layer of the switching elements (pixel switches SW) are provided between the first insulating substrate 10 and the first insulating film 11. Further, the source and drain electrodes of the switching elements are formed on the first insulating film 11.

The second insulating film 12 is provided on the signal lines S and the first insulating film 11. The common electrodes COME are formed on the second insulating film 12. The common electrodes COME are formed as a plurality of segments. These segments extend in an X-direction and are arranged in the Y-direction at predetermined intervals. The common electrodes COME are formed of a transparent conductive material such as indium tin oxide (ITO) or indium zinc oxide (IZO). In the example shown in FIG. 3, metal layers ML are formed on the common electrodes COME. The resistance of the common electrodes COME is made low. The metal layers ML may be omitted.

The third insulating film 13 is provided on the common electrodes COME and the second insulating film 12. The pixel electrodes PE are formed on the third insulating film 13. Each pixel electrode PE is located between adjacent signal lines S and faces the common electrodes COME. Each pixel electrode PE includes a slit SL at a position corresponding to the common electrodes COME. These pixel electrodes PE are formed of, for example, a transparent conductive material such as ITO or IZO. The first alignment film AL1 covers the pixel electrodes PE and the third insulating film 13.

The second substrate SUB2 is formed by using a phototransmissive second insulating substrate 20 such as a glass or resinous substrate. The second substrate SUB2 includes, on the side of the second insulating substrate 20 facing the first substrate SUB1, a black matrix BM, color filters CFR, CFG and CFB, an overcoat layer OC, a second alignment film AL2, etc.

The black matrix BM is formed on the inner surface of the second insulating substrate 20, and defines the pixels. Color filters CFR, CFG and CFB are formed on the inner surface of the second insulating substrate 20 and partially overlap the black matrix BM. Color filters CFR are red color filters. Color filters CFG are green color filters. Color filters CFB are blue color filters. The overcoat layer OC covers color filters CFR, CFG and CFB. The overcoat layer OC is formed of a transparent resinous material. The second alignment film AL2 covers the overcoat layer OC.

For example, the color filters and black matrix may be formed on the first insulating substrate 10. The color filters may be stacked on, for example, the pixel electrodes PE.

The touch detection electrodes Rx are formed on the outer surface of the second insulating substrate 20. The touch detection electrodes Rx are formed in an island shape. Here, lead lines are omitted for the sake of convenience. The touch detection electrodes Rx are formed of a metal material such as aluminum (Al), titanium (Ti), silver (Ag), molybdenum (Mo), tungsten (W), copper (Cu) or chromium (Cr), alloy prepared by combining these metal materials, a transparent conductive material such as ITO or IZO, a conductive organic material, or a dispersion element of fine conductive substances. The touch detection electrodes Rx may have either a single-layer structure or multilayer structure formed of the above materials. As an example of the multilayer structure, each touch detection electrode Rx includes a metal thin line formed of the above metal materials, and a transparent conductive material. When a metal material is used for each touch detection electrode Rx, mesh processing may be applied. In this case, a process for making each touch detection electrode Rx invisible may be applied, such as plate processing with a black material.

The backlight unit BL is provided on the rear side of the display panel PNL as described above. The first optical element OD1 is provided between the first insulating substrate 10 and the backlight unit BL. The second optical element OD2 is provided on the touch detection electrodes Rx. Each of the first and second optical elements OD1 and OD2 includes at least a polarizer. Each of the first and second optical elements OD1 and OD2 may include a retardation film depending on the need.

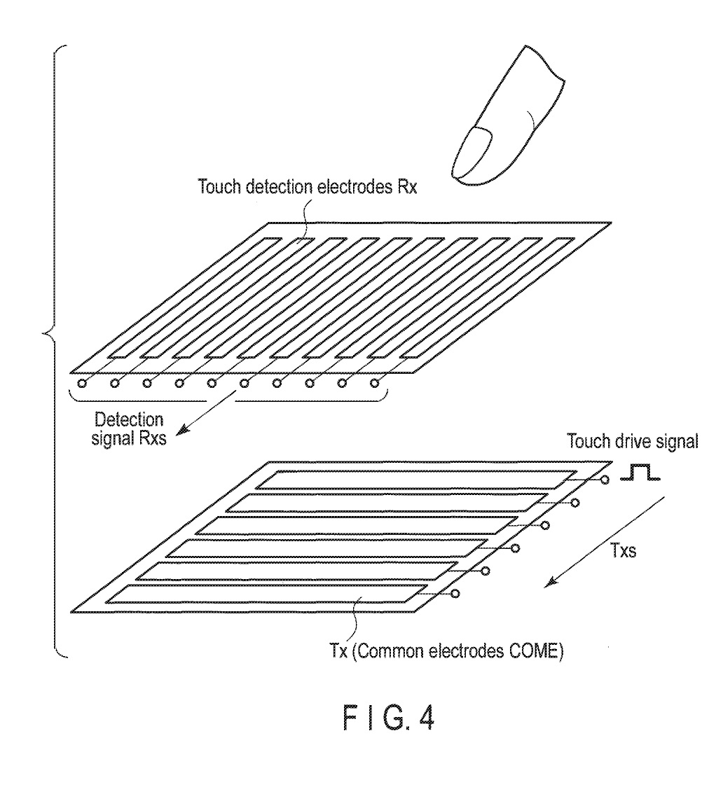

FIG. 4 is shown for explaining the basic operation of the touch detection mechanism SE. FIG. 4 shows the touch detection mechanism SE in a mutual (mutual capacitive) detection system. The touch detection system of the touch detection mechanism SE may be another detection system such as a self-detection system.

In the touch detection mechanism SE in a mutual detection system, for example, the touch detection electrodes (detection elements) Rx are formed in a stripe fashion in the Y-direction on the second substrate SUB2, and further, drive electrodes Tx are formed in a stripe fashion in the X-direction on the first substrate SUB1. The touch detection electrodes Rx intersect the drive electrodes Tx. For the drive electrodes Tx, the above common electrodes COME for image display are used.

The touch detection electrodes Rx may be formed in a stripe fashion in the X-direction, and the drive electrodes Tx may be formed in a stripe fashion in the Y-direction.

In this structure, the common electrodes COME used as the drive electrodes Tx are sequentially driven by the drive signals (touch drive signals) Txs of a high-frequency pulse in the touch detection periods described later. In this case, for example, a touch detection signal Rxs at low level is detected from a touch detection electrode Rx close to a detection object (external close object) in comparison with the output from the other touch detection electrodes Rx. In addition to the first capacitance generated between the touch detection electrode Rx close to the detection object and the common electrode COME, second capacitance is generated between the touch detection electrode Rx and the common electrode COME. Thus, the touch detection electrode Rx is capable of outputting a touch detection signal Rxs based on the change in the capacitance based on the external close object.

In the touch detection mechanism SE, it is possible to determine the coordinate position of the detection object based on the drive timing of the common electrode COME as the drive electrode Tx and the position of the touch detection electrode Rx which has output a detection signal Rxs at low level.

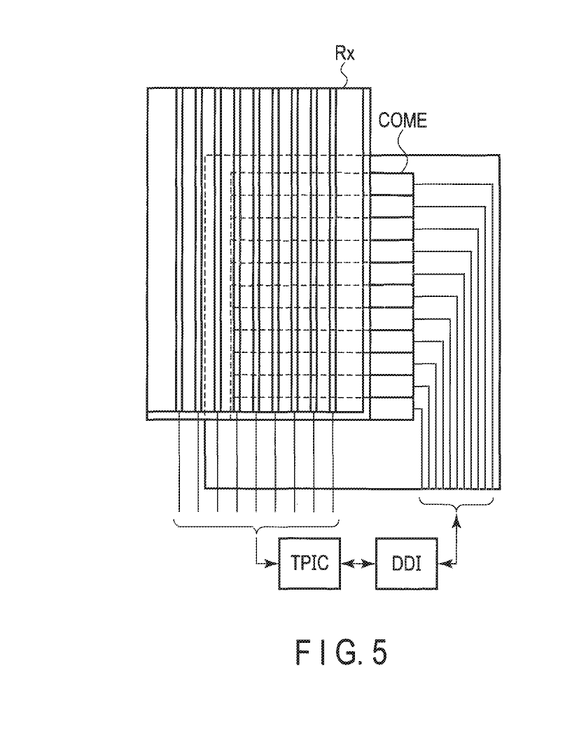

FIG. 5 is shown for explaining a structural example of the common electrodes COME (drive electrodes Tx) and the touch detection electrodes Rx.

In the display device DSP of the present embodiment, a drive pulse TSVCOM (touch drive signal Txs) is input to the common electrodes COME by the cooperation between the panel driver IC1 (DDI) and the touch driver IC2 (TPIC), and a detection pulse (touch detection signal Rxs) is obtained from the touch detection electrodes Rx. The touch driver IC2 recognizes the contact position of the detection object based on the positions of the common electrodes COME to which a drive pulse TSVCOM is input and the waveform of the detection pulse. The calculation of the contact position (touch position) may be performed by an external device (for example, the host device HOS; not shown). The details of reception signals between the panel driver IC1 and the touch driver IC2 are explained later.

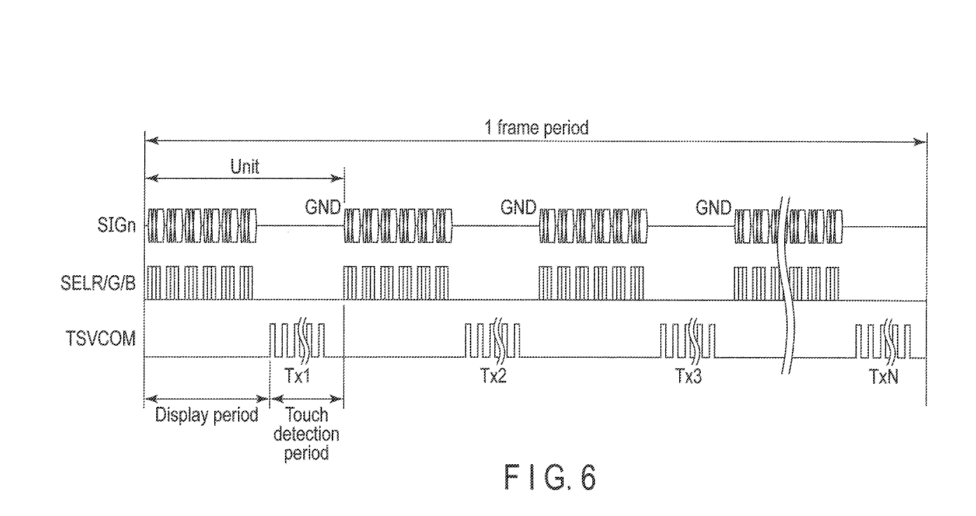

Now, this specification explains the relationship between display periods and touch detection periods in the display device DSP with reference to FIG. 6.

In the present embodiment, each display period includes a period in which operation for displaying an image on the display panel PNL (operation for driving the display pixels PX by the gate driver GD and the source driver SD) is performed. Each touch detection period includes a period in which touch detection operation for supplying a touch drive signal Txs to the above common electrodes COME (drive electrodes Tx) and detecting a touch detection signal Rxs is performed. As the drive electrodes Tx to which a touch drive signal Txs is supplied in each touch detection period, as described above, a plurality of stripe common electrodes COME are used. Since the common electrodes COME used for image display are also used as the drive electrodes Tx for touch detection, in the present embodiment, display operation and touch detection operation are performed in a time-sharing system.

Specifically, as shown in FIG. 6, each period in which the image of a single frame is displayed by the above display operation (hereinafter, referred to as each frame period) includes a plurality of units. Each unit is divided into a display period and a touch detection period. In the period of each unit, operation (display operation) for outputting the pixel signal (SIGn) of a color corresponding to a signal (SELR/G/B) selecting one of three colors RGB is performed for a plurality of display rows (lines) in the display period, and subsequently, operation (touch detection operation) for supplying a touch drive signal Tx to the common electrodes COME as the drive electrodes Tx is performed in the touch detection period. As stated above, each frame period includes a plurality of units. Thus, a display period and a touch detection period are alternately repeated in each frame period.

The control related to display operation and touch detection operation is performed by the panel driver IC1 in the present embodiment.

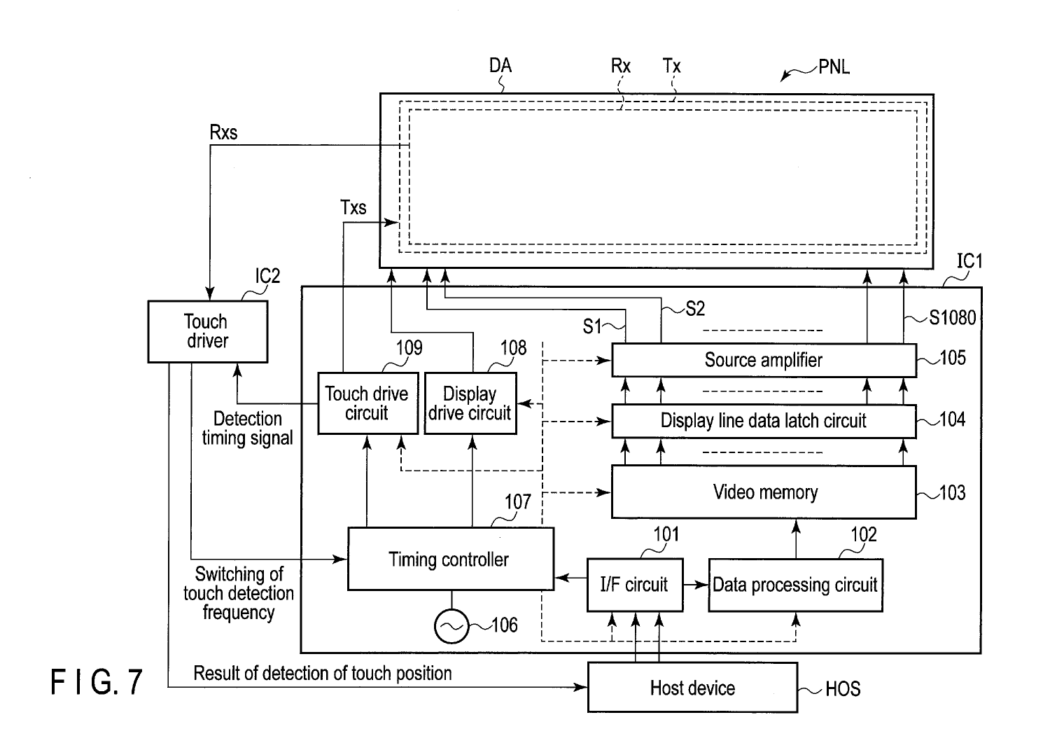

FIG. 7 mainly shows an example of the circuit structure inside the panel driver IC1. As shown in FIG. 7, the panel driver IC1 includes an interface (I/F) circuit 101, a data processing circuit 102, a video memory 103, a display line data latch circuit 104, a source amplifier 105, an internal oscillator 106, a timing controller 107, a display drive circuit 108 and a touch drive circuit 109.

As described above, the panel driver IC1 is connected to the host device HOS. The host device HOS outputs pixel data, a synchronous signal, etc. The pixel data and synchronous signal output from the host device HOS are received by the interface circuit 101.

The pixel data received by the interface circuit 101 is input to the data processing circuit 102. The data processing circuit 102 applies an interpolating process, a synthesis process, etc., to the input pixel data to conform the data to the display by the display panel PNL.

The pixel data subjected to an interpolating process and a synthesis process by the data processing circuit 102 (the pixel data output from the data processing circuit 102) is written to the video memory 103. For example, the whole image of a single frame (specifically, the pixel data of the whole image of a single frame) can be stored in the video memory 103. For the video memory 103, for example, an SRAM or a DRAM may be used.

The display line data latch circuit 104 latches the pixel data written to the video memory 103. The source amplifier 105 applies analog conversion to the pixel data latched by the display line data latch circuit 104 such that the pixel data is converted into a pixel signal. Gamma correction is applied to the pixel signal. Subsequently, the pixel signal is supplied to the display panel PNL. The pixel signal is written to each display pixel PX in which the gate is open (in other words, each pixel PX in which on-voltage is applied to the gate electrode of the pixel switch SW) via signal lines S (for example, S1 to S1080). In this way, operation for displaying an image is performed on the display panel PNL.

For example, the timing controller 107 operates all the circuit blocks inside the panel driver IC1 in synchronization with each other based on a command received from the host device HOS. The timing controller 107 receives a basic clock from the internal oscillator 106. The timing controller 107 generates various timing signals based on the basic clock. The timing controller 107 is capable of controlling the increase or decrease in the oscillating frequency of the internal oscillator 106.

The timing controller 107 includes a phase control circuit, controls the relationship between the clock (internal clock) phase of the internal oscillator 106 and the phase of the synchronous signal of an external device (host device HOS) so as to be a predetermined relationship, and maintains the controlled relationship. The timing controller 107 generates timing signals (a perpendicular synchronous signal and a horizontal synchronous signal) for writing pixel signals based on the internal clock. In this case, the timing controller 107 generates an internal perpendicular synchronous pulse and horizontal synchronous pulse.

The timing signals generated by the timing controller 107 are supplied to, for example, the display drive circuit 108 and the touch drive circuit 109. The timing controller 107 generates various timing signals and supplies them to the interface circuit 101, the data processing circuit 102, the video memory 103, the display line data latch circuit 104 and the source amplifier 105.

In this manner, the timing controller 107 is capable of integrally controlling the blocks inside the panel driver IC1 as described above.

The display drive circuit 108 is capable of controlling the source driver (source selection circuit) SD and the gate driver GD and specifying the line to which a pixel signal should be written (specifically, display pixels PX corresponding to the line) based on the timing signals from the timing controller 107.

The touch drive circuit 109 outputs a perpendicular synchronous signal and a horizontal synchronous signal to the touch driver IC2 as timing signals related to touch detection operation. The touch drive circuit 109 supplies the above drive signal Txs to the common electrodes COME in the allocated time (specifically, a touch detection period). In this way, a touch detection signal Rxs is output from the touch detection electrodes Rx.

The touch detection signal Rxs output from the touch detection electrodes Rx is input to the touch driver IC2 from the touch detection electrodes Rx. The touch driver IC2 detects (determines) the touch position based on the temporal relevance between the drive timing of the drive signal Txs and the detection timing of the touch detection signal Rxs. The result of detection of the touch position is output to the host device HOS. In this case, the host device HOS performs various processes (programming operation) based on the result of detection of the touch position output by the touch driver IC2.

The touch driver IC2 is capable of providing the timing controller 107 with a signal for switching the touch detection frequency. In the case of normal driving of the display device DSP of the present embodiment, the display drive frequency (refresh rate) and the touch detection frequency of the display device DSP are, for example, 60 Hz. The display drive frequency is equivalent to the perpendicular synchronous frequency, and indicates the number of frames rewritten per unit time by the display operation on the display panel PNL. The touch detection frequency is the frequency for scanning the display surface (touch operation surface), and indicates the drive frequency (the frequency of touch drive signals Txs) of the drive electrodes Tx (common electrodes COME) forming the touch detection mechanism SE.

When the sensitivity for touch detection is increased in comparison with the above normal driving, the touch driver IC2 is capable of providing the timing controller 107 with a signal for switching the touch detection frequency to 120 Hz. The conditions for switching the touch detection frequency may be set in advance in the display device DSP.

Now, this specification explains the outline of the operation of the display device DSP according to the present embodiment. In the present embodiment, it is assumed that the display device DSP can be driven in a plurality of drive modes (drive states). The drive modes include at least a normal drive mode (a first drive mode) and a low-speed drive mode (a second drive mode). The normal drive mode is a drive mode for driving the display device DSP at the display drive frequency of normal driving (for example, 60 Hz). The low-speed drive mode is a drive mode for driving the display device DSP at a display drive frequency (for example, 30 Hz) less than the display drive frequency of normal driving (in other words, low-frequency driving).

In the display device DSP, it is possible to save power (in other words, reduce power consumption) by dynamically switching the drive mode from the normal drive mode to the low-speed drive mode.

For example, the drive mode is switched from the normal drive mode to the low-speed drive mode by the panel driver IC1 (specifically, the timing controller 107 provided in the panel driver IC1) based on the pixel data written to the video memory 103.

Specifically, for example, when a home screen is displayed on the display device DSP (specifically, on the display panel PNL of the display device DSP), or when the screen (image) is not rewritten as the same picture is displayed (in other words, when the pixel data from the host device HOS is not written to the video memory 103 in a predetermined period), the display device DSP is less affected by the operation in the low-speed drive mode in terms of the image quality, etc. In such a case, the panel driver IC1 is capable of switching the drive mode of the display device DSP from the normal drive mode to the low-speed drive mode.

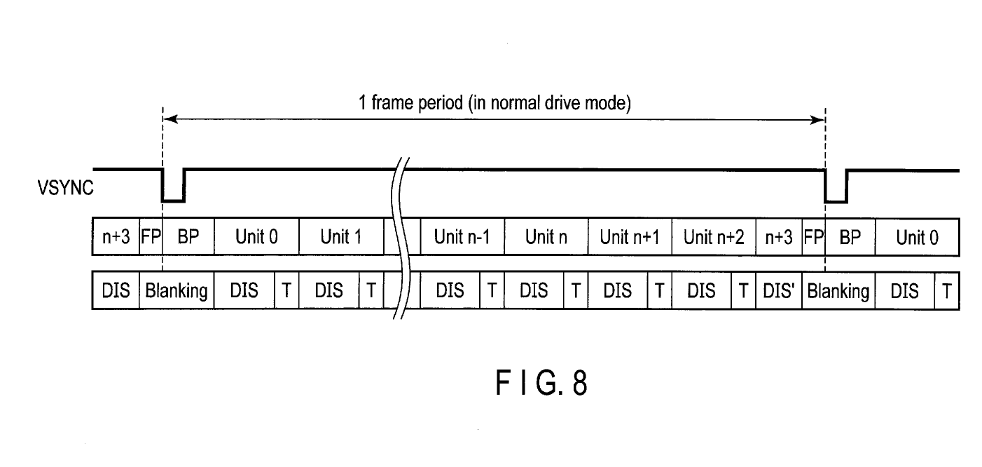

Now, this specification explains the arrangement of display periods, touch detection periods and display adjustment periods in each frame period in the normal drive mode with reference to FIG. 8. FIG. 8 shows each display period DIS in which display operation is performed, and each touch detection period T in which touch detection operation is performed.

As shown in FIG. 8, after a perpendicular synchronous signal VSYNC for display is input to the panel driver IC1, display operation and touch detection operation are performed via a perpendicular back porch period BP. The perpendicular back porch period BP is equivalent to the period from the start of each frame period (perpendicular synchronous time) until the start of writing of data (pixel signals) to the first line of the image of a single frame. In the perpendicular back porch period BP, a predetermined number of lines are driven.

The display periods DIS and the touch detection periods T are managed based on each unit. Each unit includes a display period DIS and a touch detection period T. A plurality of units are set in each frame period. In this way, in each frame period, display operation and touch detection operation are repeatedly performed (in other words, a display period DIS and a touch detection period T are alternately provided without overlapping each other).

In the present embodiment, the number of display lines to which pixel signals are written in the display period of each unit (hereinafter, referred to as the number of display lines in each unit) is set in, for example, the register in advance. Thus, in the display period DIS included in each unit, for example, the lines of the number of display lines in each unit set in the register are driven, and pixel signals are written to display pixels PX corresponding to the lines (in other words, display operation is performed). In the touch detection period T included in each unit, similarly, for example, the common electrodes COME used as the driven electrodes Tx set in advance are driven, and touch detection signals Rxs are output from the touch detection electrodes Rx (in other words, touch detection operation is performed).

The cycle of display operation for displaying the screen of a single frame is set so as to be equivalent to a single frame period. Further, the number of display lines in each unit and the number of units are set so as to display the screen (image) of a single frame in the frame period. The cycle of touch detection operation (in other words, the cycle for supplying touch drive signals Txs to the drive electrodes Tx provided in the touch detection mechanism SE) is controlled such that the integral multiple of the cycle of touch detection operation, for example, one or two cycles of touch detection operation conform to the cycle of display operation (a single frame period).

The display operation and the touch detection operation in each frame period (repetition) end when the number of lines to which pixel signals are written by display operation has reached the maximum number of display lines. The maximum number of display lines is the number of lines to which pixel signals are written in the image of a single frame. The remaining display lines are (the remainder obtained when the maximum number of display lines is divided by the number of display lines in each unit is) allocated for the last unit (specifically, the display period included in the last unit). Thus, the number of display lines of the last unit (unit n+3 shown in FIG. 8) is less than the number of display lines in each of the previous units.

When the display operation and the touch detection operation in each frame period end, the above operation in each frame period is repeated via a perpendicular front porch period FP. The perpendicular front porch period FP is equivalent to the period after the completion of writing of data (pixel signals) to the last line of the image of a single frame until the input of the next perpendicular synchronous signal VSYNC. In the perpendicular front porch period FP, a predetermined number of lines are driven.

The above perpendicular back porch period BP and perpendicular front porch period FP are called display adjustment periods. The display adjustment periods function to, for example, prepare for polarity inversion, perform calculation in an internal image process, read data or perform an expulsion processing in the gate driver (scanner). The number of lines driven in each perpendicular back porch period BP and each perpendicular front porch period FP is determined in advance by, for example, the specification of the display panel PNL.

In the present embodiment, when the display device DSP is driven in the low-speed drive mode, the difference between the time that the writing of pixel data to the first pixel row of each frame is started and the time that the writing of pixel data to the last pixel row of the frame ends is constant both in the low-speed drive mode and in the normal drive mode. In the present embodiment, the length of the display period DIS and the touch detection period T included in each unit in the low-speed drive mode is the same as that in the normal drive mode.

As described above, each frame period in the low-speed drive mode is longer than that in the normal drive mode. The present embodiment deals with the difference from each frame period in the normal drive mode by lengthening display adjustment periods. The display adjustment periods include perpendicular back porch periods BP in which the polarity of display of an image is inverted, and perpendicular front porch periods FP provided after display periods and touch detection periods. Either perpendicular back porch periods BP or perpendicular front porch periods FP may be lengthened in the low-speed drive mode. In the present embodiment, each perpendicular front porch period FP is lengthened (extended). A first frame period is a frame period in the normal drive mode.

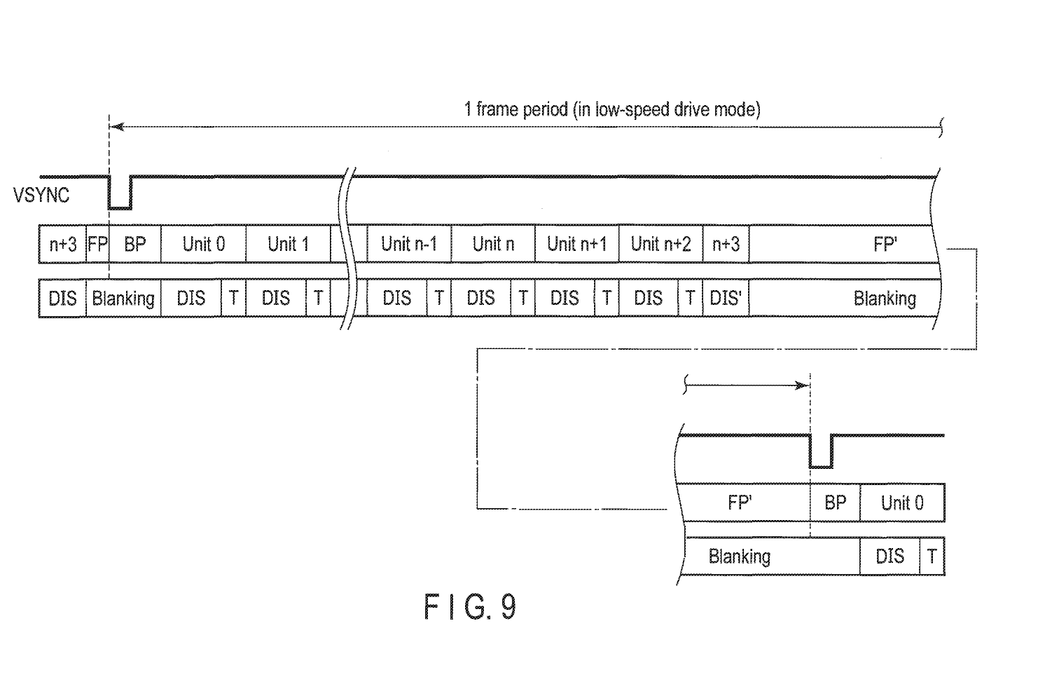

Now, this specification explains the arrangement of display periods, touch detection periods and display adjustment periods in each frame period in the low-speed drive mode with reference to FIG. 9. A second frame period is a frame period in the low-speed drive mode.

As shown in FIG. 9, each perpendicular back porch period BP and each unit (including a display period DIS and a touch detection period T) in the low-speed drive mode are the same as those of normal driving shown in FIG. 8. However, each perpendicular front porch period FP′ is longer than each perpendicular front porch period FP in the normal drive mode.

When the panel driver IC (specifically, the interface circuit 101 provided in the panel driver IC) receives the pixel data output from the host device HOS while the display device DSP is driven in the low-speed drive mode, it is necessary to rewrite the screen based on the pixel data. Thus, it is preferable that the display device DSP promptly return from the low-speed drive mode to the normal drive mode. The return from the low-speed drive mode to the normal drive mode is performed after the completion of a frame period in the low-speed drive mode (in other words, at the time of transitioning to the next frame period).

In some cases, the host device HOS which outputs pixel data does not recognize the drive mode (the normal drive mode or the low-speed drive mode) of the display device DSP. In these cases, pixel data is output from the host device HOS at an arbitrary time unrelated to, for example, a synchronous signal VSYNC (in other words, each frame cycle) inside the display device DSP (specifically, the display panel PNL provided in the display panel DSP). For example, the pixel data output from the host device HOS may be received in the middle of a frame period in the low-speed drive mode. In this case, the display device DSP can return (be switched) to the normal drive mode only after the completion of the frame period. The screen cannot be rewritten until the frame period ends. As described above, each frame period in the low-speed drive mode is longer than that in the normal drive mode. Thus, the waiting time for the end of the frame period (in other words, for the transition to the next frame period) is long. For example, a delay in displaying a new screen (in updating the screen) may occur.

For example, it is assumed that the frame frequency in the normal drive mode is 60 Hz, and the frame frequency in the low-speed drive mode is 5 Hz (= 1/12 of 60 Hz). When the display device DSP operates in the low-speed drive mode, and further when pixel data is received in the beginning of a frame from the host device HOS, the drive mode is switched to the normal drive mode after twelve frames at a maximum in the frame rate of the normal drive mode.

In the present embodiment, the panel driver IC1 provided in the display device DSP has a function for appropriately switching the drive mode of the display device DSP by using the pixel data output from the host device HOS during a frame period in the low-speed drive mode as a switch signal (a signal for switching the low-speed drive mode to the normal drive mode).

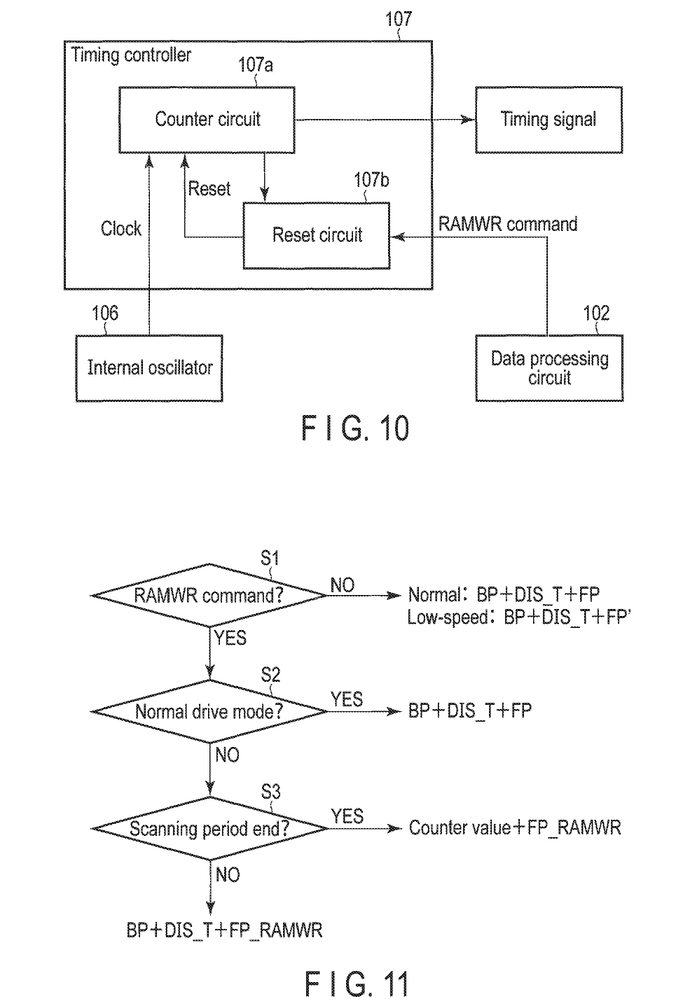

FIG. 10 shows an example of the configuration of the timing controller 107 for realizing the above function of the panel driver IC1.

As shown in FIG. 10, the timing controller 107 includes a counter circuit 107a and a reset circuit 107b.

The counter circuit 107a is a circuit for mainly counting the elapse of each frame period (specifically, the display periods, touch detection periods and display adjustment periods included in each frame period) based on the clock of the internal oscillator 106. It is possible to manage, for example, the number of display lines to which pixel signals are written in each display period included in each frame period, using the counter circuit 107a. The value counted by the counter circuit 107a (hereinafter, referred to as a counter value) is output to each component inside the panel driver IC1 as the above timing signal.

The reset circuit 107b is a circuit for resetting the count made by the counter circuit 107a. The reset circuit 107b obtains the counter value of the counter circuit 107a. When the counter value obtained from the counter circuit 107a has reached a value corresponding to the elapse of each frame period based on the current drive mode, the reset circuit 107b resets the count made by the counter circuit 107a. In this way, the counter circuit 107a is capable of repeatedly counting the elapse of each frame period.

For example, when pixel data is output from the host device HOS while the display device DSP is in the low-speed drive mode, the data processing circuit (command register) 102 writes the pixel data subjected to an interpolating process and a synthesis process to the video memory 103, and outputs a command (a RAMWR command) indicating that the pixel data is written to the video memory 103 to the timing controller 107. The RAMWR command is equivalent to a switch signal for switching (returning) the drive mode of the display device DSP from the low-speed drive mode to the normal drive mode.

When a RAMWR command is output from the data processing circuit 102 as described above, the reset circuit 107b determines whether the display periods of the frame period end (in other words, whether the counter value has reached a value corresponding to the maximum number of display lines) based on the counter value of the counter circuit 107a.

When the reset circuit 107b determines that the display periods of the frame period end, the reset circuit 107b resets the counter value of the counter circuit 107a after the end of a period for the preparation for displaying an image based on the pixel data output from the host device HOS (in other words, the next image).

When the reset circuit 107b determines that the display periods of the frame period do not end, the reset circuit 107b resets the counter value of the counter circuit 107a after the end of the display periods.

Since the timing controller 107 has the above structure, it is possible to shortening the frame period in the low-speed drive mode by resetting the counter value based on a RAMWR command (switch signal). In this way, after the end of the frame period in the low-speed drive mode, the drive mode of the display device DSP can be switched from the low-speed drive mode to the normal drive mode. Subsequently, the next frame period can be started.

Now, this specification explains the outline of the operation of the timing controller 107 shown in FIG. 10 with reference to the flowchart of FIG. 11.

It is assumed that the counter circuit 107a included in the timing controller 107 counts the elapse of each frame period.

When pixel data is written to the video memory 103 as described above, the data processing circuit 102 outputs a RAMWR command. The RAMWR command output from the data processing circuit 102 is received in the timing controller 107.

The reset circuit 107b included in the timing controller 107 determines whether the timing controller 107 receives any RAMWR command output from the data processing circuit 102 as described above (step S1).

When the reset circuit 107b determines that no RAMWR command is received (NO in step S1), the reset circuit 107b continues the normal operation (in other words, the current drive mode).

Specifically, when the display device DSP is driven in the normal drive mode, and further when it is determined that each frame period (including a perpendicular back porch period BP, a scanning period DIS T and a perpendicular front porch period FP) in the normal drive mode ends based on the counter value of the counter circuit 107a, the reset circuit 107b resets the counter value. Each scanning period DIS T is a period in which display operation and touch detection operation are repeated in each frame period (in other words, a period from the start to the end of display operation and touch detection operation).

When the display device DSP is driven in the low-speed drive mode, and further when it is determined that each frame period (including a perpendicular back porch period BP, a scanning period DIS T and a perpendicular front porch period FP′) in the low-speed drive mode ends based on the counter value of the counter circuit 107a, the reset circuit 107b resets the counter value. Each perpendicular front porch period FP′ is a perpendicular front porch period in the low-speed drive mode. Each perpendicular front porch period FP′ in the low-speed drive mode is longer than each perpendicular front porch period EP in the normal drive mode as described above.

When the reset circuit 107b determines that a RAMWR command is received in step S1 (YES in step S1), whether the display device DSP is driven in the normal drive mode (in other words, whether the drive mode of the display device DSP is the normal drive mode) is determined (step S2). The drive mode of the display device DSP is set (managed) in, for example, the timing controller 107.

When it is determined that the display device DSP is driven in the normal drive mode (YES in step S2), and further when it is determined that that each frame period (including a perpendicular back porch period BP, a scanning period DIS T and a perpendicular front porch period FP) in the normal drive mode ends based on the counter value of the counter circuit 107a, the reset circuit 107b resets the counter value.

When it is determined that the display device DSP is not driven in the normal drive mode (in other words, the display device DSP is driven in the low-speed drive mode) (NO in step S2), the reset circuit 107b determines whether the scanning period DIS T ends in the current frame period (in the low-speed drive mode) based on the counter value of the counter circuit 107a (step S3).

When the reset circuit 107b determines that the scanning period ends (YES in step S3), the reset circuit 107b refers to the counter value of the counter circuit 107a and resets the counter value after the counter circuit 107a counts the elapse of a predetermined time. In other words, the reset circuit 107b resets the counter value when the counter value of the counter circuit 107a has reached the current counter value+FP_RAMWR. FP_RAMWR indicates, for example, the counter value for counting the elapse of a period equivalent to a preparation period for the display operation and touch detection operation in the next frame period. As FP_RAMWR, for example, a value configured to ensure a period for wiring data to several lines as a preparation period is set in advance.

When the reset circuit 107b determines that the scanning period does not end (NO in step S3), the reset circuit 107b resets the counter value when it is determined that the period of a perpendicular back porch period BP, a scanning period DIS T and FP_RAMWR ends based on the counter value of the counter circuit 107a.

The above embodiment of FIG. 10 and FIG. 11 is merely an example. Various forms may be applied to the structure of generating a timing signal for obtaining display periods DIS, touch detection periods T, perpendicular front porch periods FP, perpendicular back porch periods BP, etc., for the normal drive mode and the low-speed drive mode. In the above explanation, the counter circuit 107a and the reset circuit 107b are shown. However, these circuits may be referred to as, for example, a mode switch circuit and a mode control circuit. In the above explanation, the timing controller 107 receives a RAMWR command from the data processing circuit 102. However, the timing controller 107 may receive a RAMWR command from the host device HOS via the interface circuit 101.

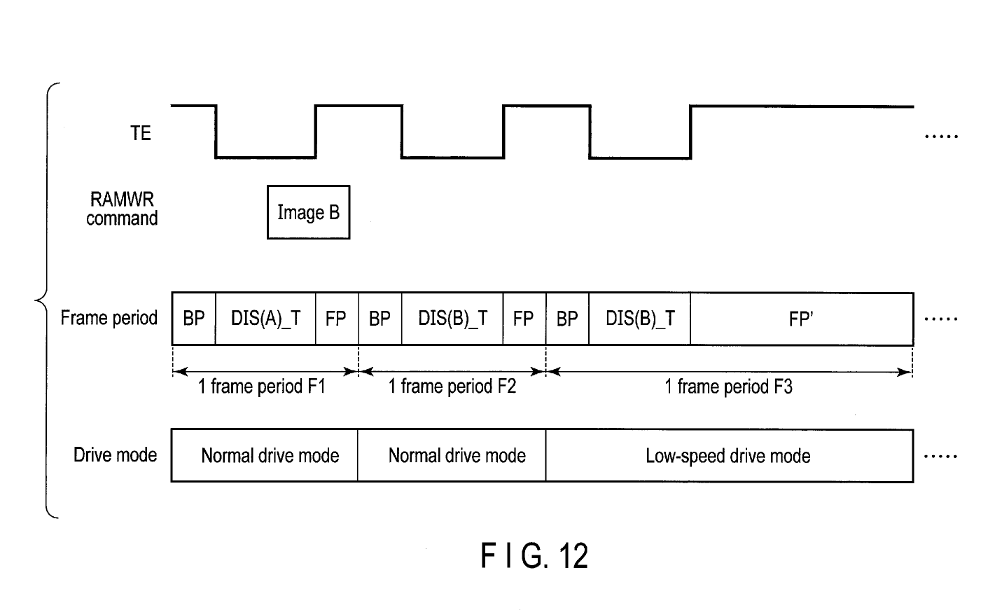

Now, with reference to FIG. 12 to FIG. 14, this specification specifically explains the transition of frame periods based on the switch of the drive mode according to the present embodiment.

FIG. 12 is shown for explaining the transition of frame periods when no RAMWR command is received in the timing controller 107 in the low-speed drive mode.

In FIG. 12, TE is a VSYNC signal (master synchronous signal) input from the panel driver IC1 to the host device HOS. It is assumed that, in each frame period, display operation is performed when TE is at low level.

In FIG. 12, the RAMWR command indicates the timing of receiving an RAMWR command in the timing controller 107.

In FIG. 12, the frame period indicates the transition of frame periods each including a perpendicular back porch period, a scanning period and a perpendicular front porch period. In FIG. 12, for example, DIS(A)_T of the frame period indicates a period (scanning period) in which the display operation and touch detection operation for displaying image A are repeated. DIS(B)_T indicates a period (scanning period) in which the display operation and touch detection operation for displaying image B are repeated. DIS(C)_T described later indicates a period (scanning period) in which the display operation and touch detection operation for displaying image C are repeated.

In FIG. 12, the drive mode indicates the drive mode (the normal drive mode or the low-speed drive mode) of the display device DSP in each frame period.

The RAMWR command, frame period and drive mode explained here are also applicable to the subsequent drawings.

As shown in FIG. 12, it is assumed that a RAMWR command related to image B is received (in other words, the pixel data of image B is written to the video memory 103) in frame period F1 including period DIS(A)_T. In this case, the display device DSP is driven in the normal drive mode in frame period F2 following frame period F1.

It is assumed that, when no RAMWR command is received in the timing controller 107 in frame period F2 (in other words, no pixel data is written to the video memory 103 in a predetermined time), the drive mode of the display device DSP is switched from the normal drive mode to the low-speed drive mode. In this configuration, the display device DSP is driven in the low-speed drive mode in frame period F3 following frame period F2.

When the display device DSP is driven in the low-speed drive mode, the perpendicular front porch period FP of frame periods F1 and F2 in the normal drive mode is extended to FP′ in frame period F3. As shown in FIG. 12, when no RAMWR command is received in the timing controller 107 while the display device DSP is driven in the low-speed drive mode, a frame period (in the low-speed drive mode) similar to frame period F3 is repeated until a RAMWR command is received.

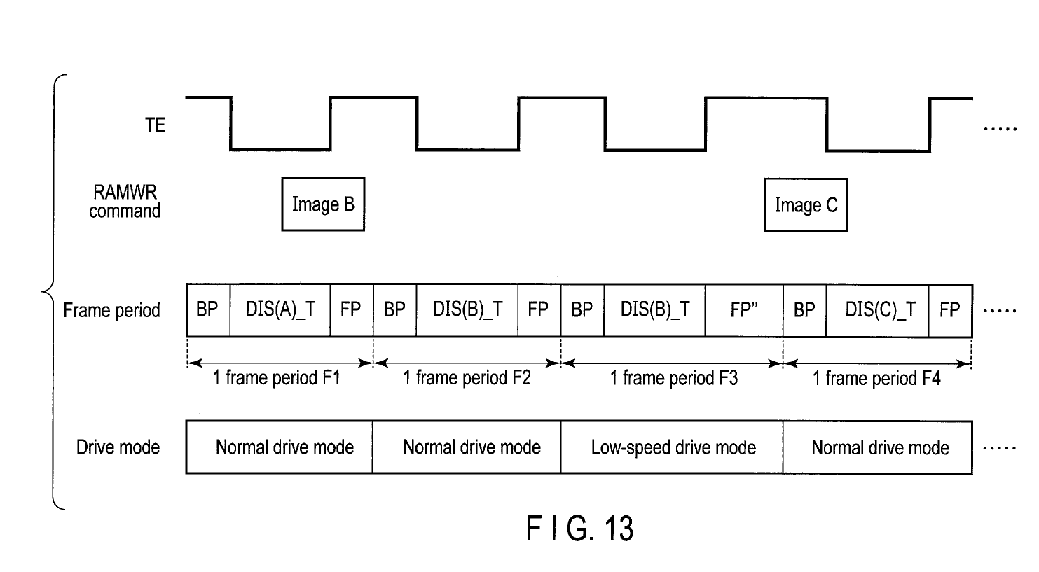

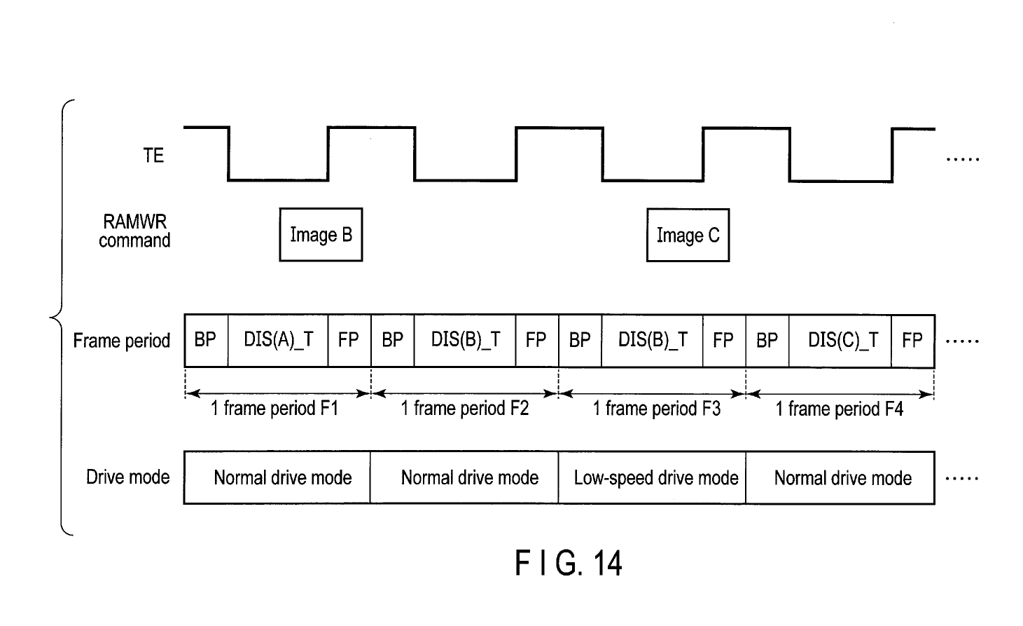

Now, this specification explains the transition of frame periods when a RAMWR command is received in the timing controller 107 in the low-speed drive mode with reference to FIG. 13 and FIG. 14.

FIG. 13 assumes that a RAMWR command (here, a RAMWR command related to image C) is received in the perpendicular front porch period FP′ in frame period F3 in the low-speed drive mode shown in FIG. 12.

In this case, as shown in FIG. 13, frame period F3 ends after the length of the perpendicular front porch period FP′ in frame period F3 is decreased to FP″. The perpendicular front porch period FP″ is equivalent to, for example, a period from the start time of the perpendicular front porch period FP′ to the elapse of a predetermined time including the above preparation period after the receipt of the RAMWR command.

After the end of frame period F3, the display device DSP transitions to frame period F4 in which the display operation and touch detection operation for displaying image C are performed. In frame period F4, the display device DSP is driven in the normal drive mode.

FIG. 14 assumes that a RAMWR command (a RAMWR command related to image C) is received in the scanning period DIS(B)_T in frame period F3 in the low-speed drive mode shown in FIG. 12.

In this case, as shown in FIG. 14, after the scanning period DIS(B)_T, in other words, after display operation and touch detection operation, the perpendicular front porch period FP which is applied when the display device DSP is driven in the normal drive mode (in other words, a short perpendicular front porch period FP) is performed. Subsequently, frame period F3 ends. Here, it is assumed that the perpendicular front porch period FP in frame period F3 shown in FIG. 14 is a period equivalent to a preparation period based on FP_RAMWR as described above.

After the end of frame period F3, the display device DSP transitions to frame period F4 explained in FIG. 13.

In the present embodiment, when a RAMWR command is received in the timing controller 107 while the display device DSP is driven in the low-speed drive mode, the display device DSP shortens the frame period in the low-speed drive mode (specifically, the perpendicular front porch period FP′) and transitions to the next frame period. Further, the display device DSP returns to the normal drive mode in the next frame period.

In the above description, touch detection operation is not performed in each perpendicular front porch period FP′ in the low-speed drive mode. However, each perpendicular front porch period FP′ is longer than each perpendicular front porch period FP in the normal drive mode. Thus, when touch detection operation is not performed in each perpendicular front porch period FP′, touch operation cannot be detected in the perpendicular front porch periods FP′. The sensitivity for touch detection in the display device DSP is decreased.

For example, under the control by the panel driver IC1 (specifically, the timing controller 107 included in the panel driver IC1), the display device DSP may perform touch detection operation in which the touch detection electrodes Rx output touch detection signals Rxs by driving the drive electrodes Tx (specifically, the common electrodes COME operating as the drive electrodes Tx) in the perpendicular front porch period FP′ of each frame period in the low-speed drive mode (in other words, the display device DSP may allocate a touch detection period T′ to the perpendicular front porch period FP′ of each frame period in the low-speed drive mode).

In this structure, when a RAMWR command is received in the perpendicular front porch period FP′ in frame period F3 as explained in FIG. 13, frame period F3 ends after the completion of the touch detection operation performed at the time of receiving the RAMWR command. The completion of touch detection operation indicates the completion of one cycle of touch detection operation (the operation for supplying touch drive signals Txs to the drive electrodes Tx provided in the touch detection mechanism SE). In this way, even in the structure of performing touch detection operation in each perpendicular front porch period FP′, the display device DSP may shorten the perpendicular front porch period FP′ after the completion of the touch detection operation and transition to the next frame period.

Now, this specification briefly explains various signals related to display operation and touch detection operation in the display device DSP according to the present embodiment.

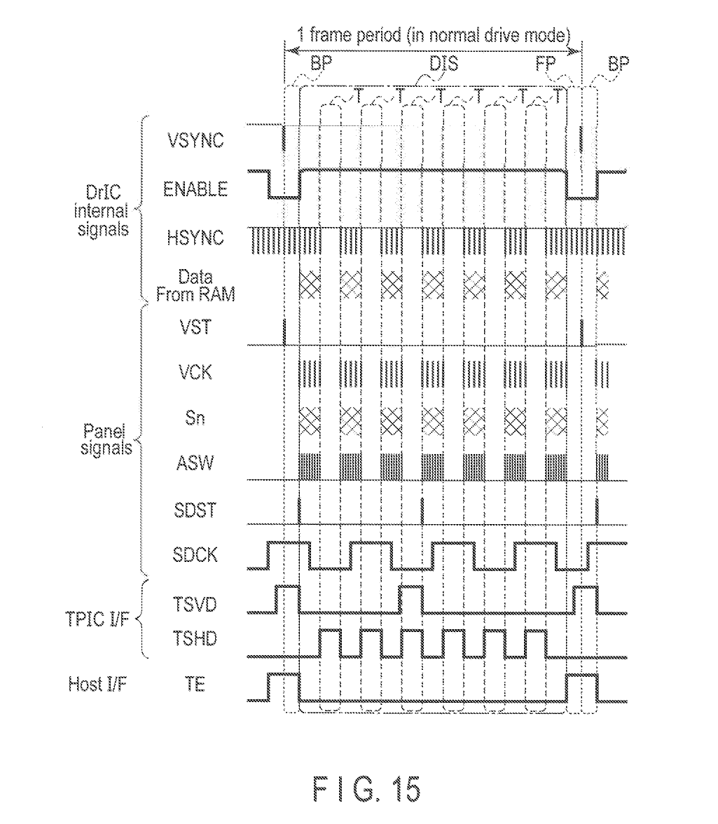

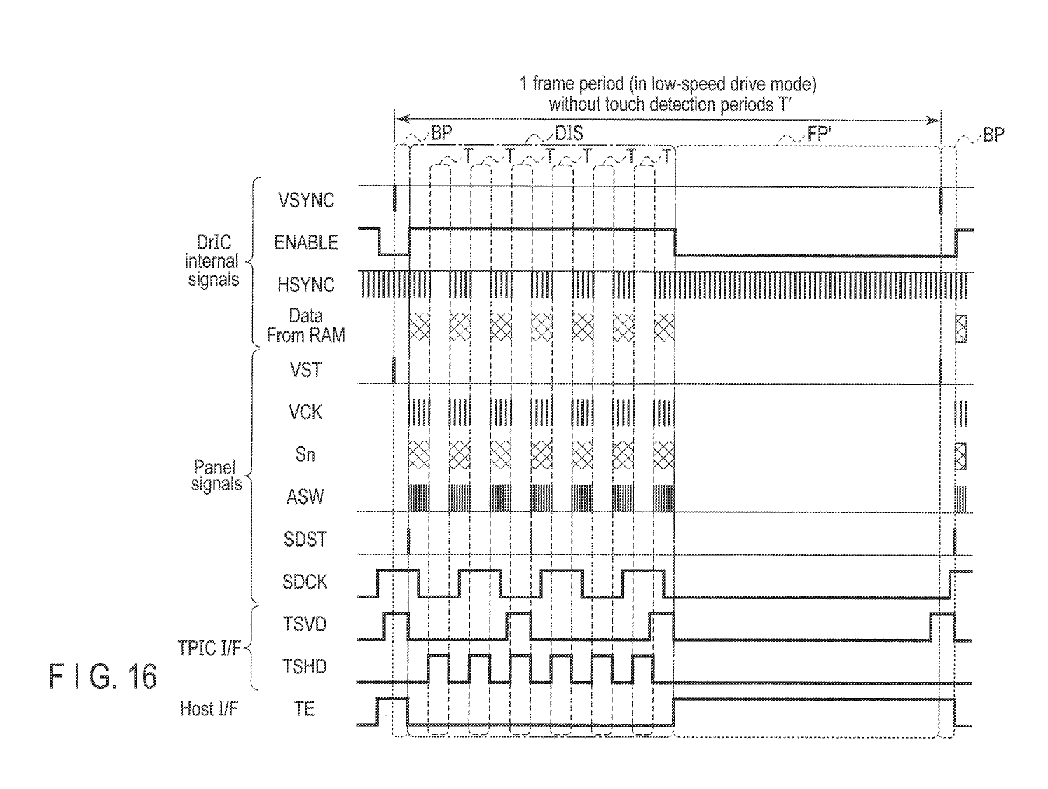

FIG. 15 is a timing chart showing the relationship of various signals in each frame period in the normal drive mode. In FIG. 15, for example, the above units are simplified for the sake of convenience. However, each frame period includes a perpendicular back porch period BP, a scanning period DIS T in which display periods DIS and touch detection periods T are alternately provided in units, and a perpendicular front porch period FP.

In FIG. 15, VSYNC, ENABLE, HSYNC and Data are shown as the internal signals of the panel driver IC1.

VSYNC is a perpendicular synchronous signal indicating the start of a frame period (the cycle of display operation). ENABLE is an enable signal indicating that a pixel signal can be written to display pixels PX. HSYNC is a horizontal synchronous signal indicating the timing of display operation based on each line on the screen of one frame. Data indicates pixel data read from the video memory 103.

According to the internal signals of the panel driver IC1 shown in FIG. 15, the enable signal is at high level a predetermined time after the input of VSYNC, and pixel data is read from the video memory 103 based on the horizontal synchronous signal in each display period DIS in each frame period.

FIG. 15 also shows VST, VCK, Sn, ASW, SDST and SDSK as the signals (panel signals) input to the display panel PNL.

VST is a gate circuit start pulse. VCK is a gate circuit shift clock (image). VST and VCK are signals for controlling the gate driver GD provided in the display panel PNL. Sn is source output, and indicates a pixel signal input from the panel driver IC1 to the display panel PNL and written to a display pixel PX via a signal line S. ASW is a multiplexer control switch, and indicates a signal for selecting, for example, RGB. SDST is a touch detection (scanning) start pulse. SDSK is a touch detection (scanning) clock. SDST and SDCK are control signals related to touch detection.

When the panel signals (VST, VCK, Sn and ASW) are input to the display panel PNL at the timing shown in FIG. 15, display pixels PX corresponding to the display lines in each unit are driven (in other words, pixel signals are written to the display pixels PX) in synchronization with the above horizontal synchronous signal in a corresponding display period DIS. SDST indicates the start of the above cycle of touch detection operation. In the example shown in FIG. 15, two cycles of touch detection operation are performed in each frame period. SDCK is input in accordance with the arrangement of the touch detection periods T in the scanning period. According to these SDST and SDCK, the drive electrodes Tx (common electrodes COME) selected by the SDST and SDCK are driven in the touch detection periods T.

FIG. 15 further shows TSVD and TSHD as the signals (TPIC I/F) input to the touch driver IC2. TSVD and TSHD are signals (a perpendicular synchronous signal and a horizontal synchronous signal) for synchronizing the panel driver IC1 with the touch driver IC2. TSVD is input based on the start of the above cycle of touch detection operation. TSHD is input so as to correspond to the touch detection periods T in the scanning period.

The touch driver IC2 is capable of detecting the touch position from the touch detection signal Rxs output from a touch detection electrode Rx in a touch detection period T based on the TSVD and TSHD input at the timing shown in FIG. 15.

FIG. 15 shows the above TE as a signal (HOST I/F) input to the host device HOS. Although not shown in FIG. 15, the touch position detected by the touch driver IC2 is output to the host device HOS. In the display device DSP, synchronized operation is realized between the panel driver IC1, the touch driver IC2 and the host device HOS by using a VSCYNC signal (master synchronous signal), TSVD, TSHD, etc.

FIG. 15 shows that neither display operation nor touch detection operation is performed in perpendicular back porch periods BP or perpendicular front porch periods FP.

FIG. 16 is a timing chart showing the relationship of various signals in each frame period in the low-speed drive mode.

As shown in FIG. 16, each perpendicular front porch period FP in the normal drive mode is extended to FP′ in the low-speed drive mode. Since neither display operation nor touch detection operation is performed in each perpendicular front porch period FP′, the relationship of various signals is similar to that of each perpendicular front porch period FP shown in FIG. 15.

In the present embodiment, when a RAMWR command is received in the timing controller 107 in each frame period in the low-speed drive mode shown in FIG. 16, the display device DSP shortens the frame period (specifically, the perpendicular front porch period FP′ included in the frame period) and transitions to the next frame period.

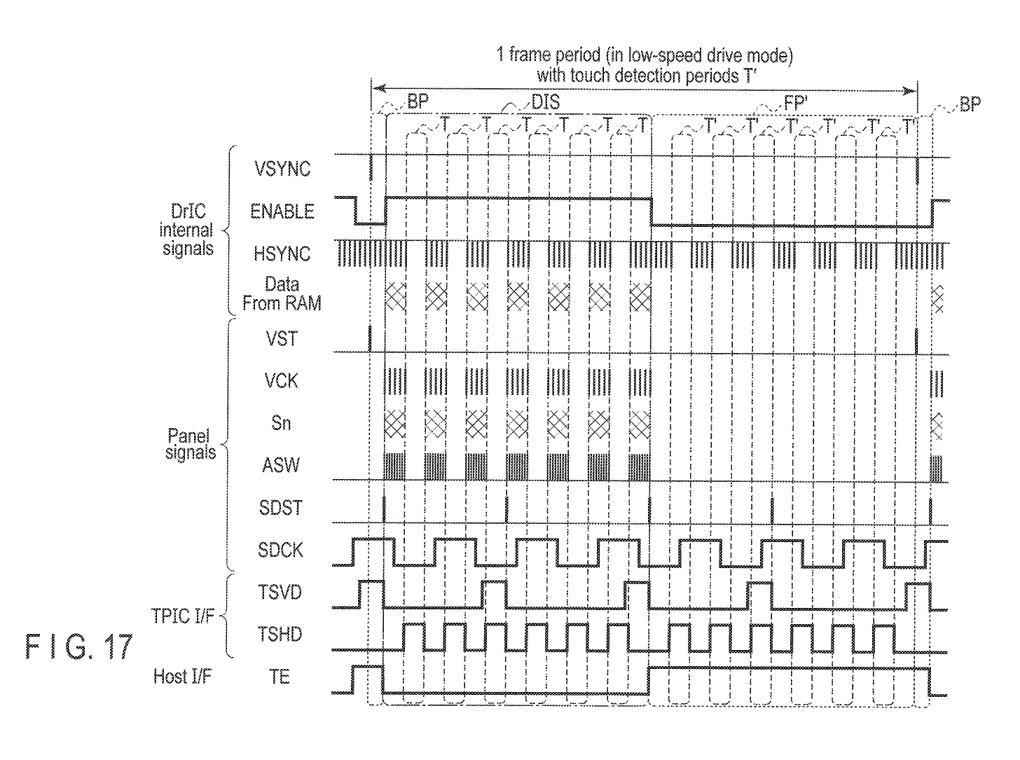

FIG. 17 is a timing chart showing the relationship of various signals when touch detection operation is performed in (in other words, touch detection periods T′ are allocated to) the perpendicular front porch period FP′ included in each frame period in the low-speed drive mode. In each frame period shown in FIG. 17, touch detection periods T′ are set in the perpendicular front porch period FP′ in comparison with FIG. 16. Specifically, in the perpendicular front porch period FP′, SDST and SDCK are input to the display panel PNL as panel signals, and TSVD and TSHD are input to the touch driver IC2. In this configuration, touch detection operation is performed even in the touch detection periods T′ arranged in the perpendicular front porch period FP′ at the same intervals as the touch detection periods T. In this way, touch detection is continuously performed even in the perpendicular front porch period FP′. Thus, a touch detection report is stably transmitted to the host device HOS. Thus, the touch detection operation of the device is stable.

As described above, in the present embodiment, when a switch signal for switching the low-speed drive mode to the normal drive mode (first drive mode) is received while the display device DSP is driven in the low-speed drive mode (second drive mode), the display device DSP shortens each frame period (second frame period) in the low-speed drive mode, transitions to the next frame period and switches the low-speed drive mode to the normal drive mode.

Specifically, when the display periods and touch detection periods included in the frame period in the low-speed drive mode are completed at the time of receiving a switch signal, the frame period is terminated in the middle of the display adjustment period included in the frame period. When the display operations and the touch detection periods included in the frame period in the low-speed drive mode are in progress at the time of receiving a switch signal, the frame period is terminated after the completion of the display periods and the touch detection periods.

Since the present embodiment is configured in this manner, the display device DSP can transition to the next frame period without waiting for the end of the frame period in the low-speed drive mode. Thus, the drive state (drive mode) of the display device DSP can be appropriately switched.

In the present embodiment, a RAMWR command is used as the above switch signal. In the present embodiment, it is possible to rewrite the screen without waiting for the end of the frame period in the low-speed drive mode by shortening (terminating) the frame period in the low-speed drive mode and transitioning to the next frame period when a RAMWR command is received in the low-speed drive mode. Thus, it is possible to avoid a delay in displaying (updating) the screen (in other words, it is possible to improve the response for switching the display).

In the above embodiment, the switch signal is a RAMWR command indicating that pixel data is written to the video memory 103. However, the switch signal may be a command output from, for example, the host device HOS.

In the present embodiment, the length of the display periods included in each frame period in the low-speed drive mode is the same as the length of the display periods included in each frame period in the normal drive mode. The display adjustment period (perpendicular front porch period) included in each frame period in the low-speed drive mode is longer than the display adjustment period included in each frame period in the normal drive mode. Since the present embodiment is configured in this way, it is unnecessary to change the display operation between the normal drive mode and the low-speed drive mode. Thus, the control related to display operation can be simplified.

In the present embodiment, instead of a perpendicular back porch period, a perpendicular front porch period is extended when the display device DSP is driven in the low-speed drive mode. Thus, the time required to complete writing an image after polarity inversion can be made constant.

In the present embodiment, when no pixel data is written to the video memory 103 in a predetermined time, the normal drive mode can be dynamically switched to the low-speed drive mode. Thus, power can be saved.

In the present embodiment, the common electrodes COME for display (the common electrodes to which display drive voltage is applied in display periods) are used as the drive electrodes Tx for touch detection (the drive electrodes to which touch drive voltage is applied). Thus, the thickness of the display device DSP can be reduced. Further, the image quality can be improved.

The reduction in the length of each frame period in the low-speed drive mode in the present embodiment can be realized by the timing controller 107 including the counter circuit 107a configured to count the elapse of each frame period (specifically, the display periods, touch detection periods and display adjustment periods included in each frame period) and the reset circuit 107b configured to reset the count of the counter circuit 107a when the low-speed drive mode is switched to the normal drive mode.

In the above embodiment, the common electrodes COME are provided along the scanning lines G. However, the present embodiment may be applied to a structure in which the common electrodes COME are provided along the signal lines S. The present embodiment is not limited to the shape of the common electrodes COME, etc. For example, the present embodiment may be applied to a structure in which a common electrode (having a block shape) is provided for each display pixel. In the above embodiment, the detection system of the touch detection mechanism SE is a mutual capacitive detection system including drive electrodes and detection electrodes. However, the detection system may be a self-capacitive detection system. In the self-capacitive detection, for example, a plurality of common electrodes are arranged in matrix to detect the change in electrode capacity between a touch and a non-touch for each common electrode.

Further, the display panel PNL of the above embodiment is a transmissive type display panel including a backlight. However, as described above, the display panel PNL may be a reflective type display panel. Further, the display panel PNL is not limited to a panel using a liquid crystal layer, and may be, for example, an organic electroluminescent panel. In the organic electroluminescent panel, the common electrodes COME may face the pixel electrodes of organic electroluminescent elements via an organic light-emitting layer to form drive electrodes.

In the above embodiment, the display device DSP includes an in-cell touch detection mechanism SE. However, the present embodiment may be applied to, for example, a display device DSP including an on-cell touch detection mechanism.

In the present embodiment, display operation and touch detection operation are repeatedly performed by employing a structure (in-cell type) in which the common electrodes COME for display are used as the drive electrodes Tx for touch detection as described above. However, the present embodiment may be applied even in a structure (a first modification) in which display operation is performed independently from touch detection operation.

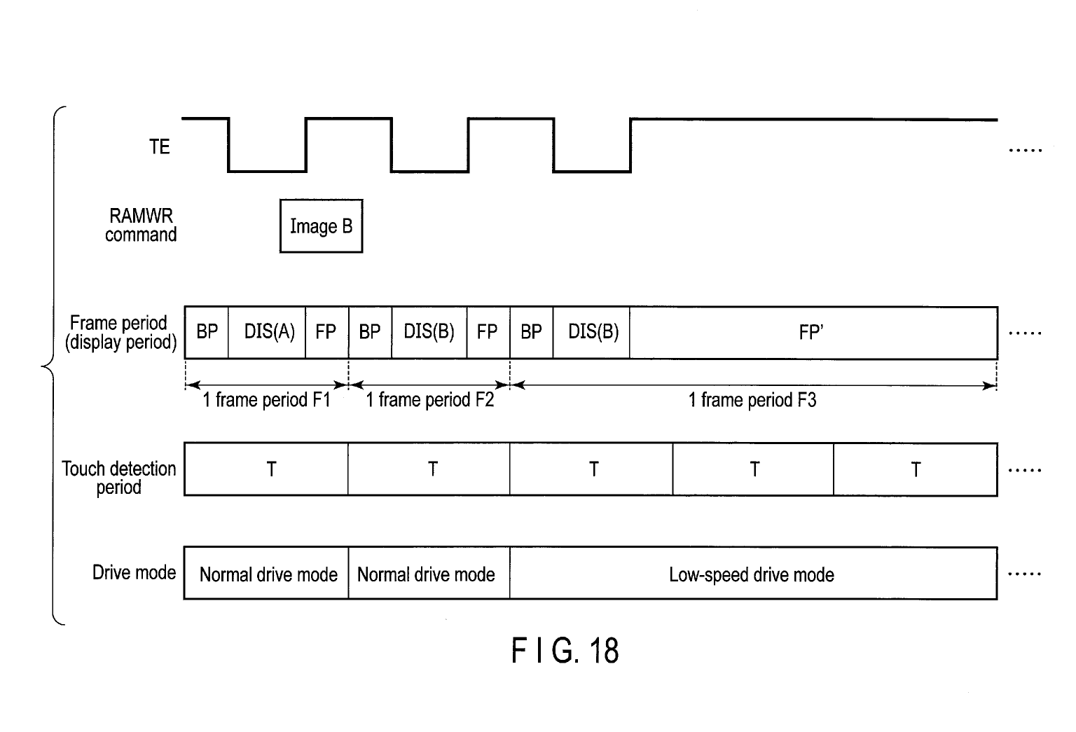

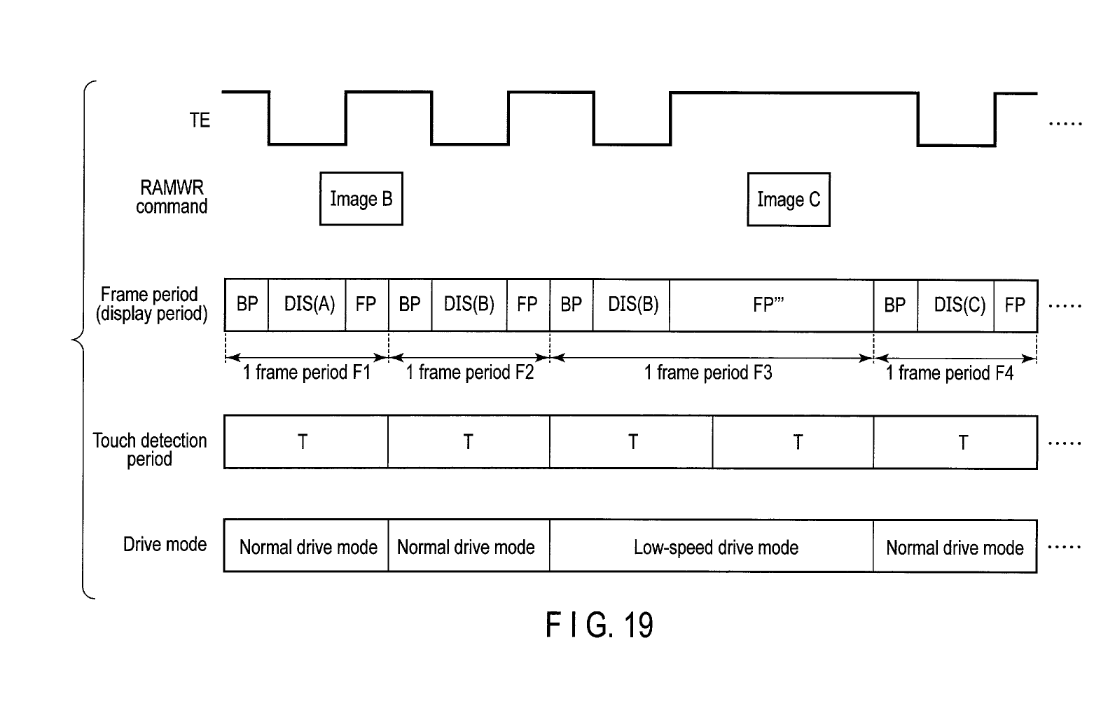

Now, this specification briefly explains the transition of frames according to an example of the first modification with reference to FIG. 18 and FIG. 19. The detailed description of the same portions as FIG. 12 and FIG. 13 is omitted.

FIG. 18 is shown for explaining the transition of frame periods when no RAMWR command is received in the timing controller 107 in the low-speed drive mode in the first modification. FIG. 19 is shown for explaining the transition of frame periods when a RAMWR command is received in the timing controller 107 in the low-speed drive mode in the modification.

In the first modification example, as shown in FIG. 18 and FIG. 19, each frame period (BP+DIS+FP) including display periods in which the image of one frame is displayed and each touch detection period T in which touch detection operation is performed are separately shown by independently performing display operation and touch detection operation. Each touch detection period T shown in FIG. 18 and FIG. 19 is equivalent to a period in which one cycle of touch detection operation is performed.

In this case, when no RAMWR command is received in the low-speed drive mode as shown in FIG. 18, a frame period similar to frame period F3 shown in FIG. 18 and touch detection periods T having the same length as frame period F3 (here, three cycles of touch detection operation) are repeated until a RAMWR command is received.

It is assumed that, as shown in FIG. 19, a RAMWR command is received in the perpendicular front porch period FP′ of frame period F3 in the low-speed drive mode. In this case, frame period F3 is terminated after the length of the perpendicular front porch period FP′ of frame period F3 is decreased to FP′″. The perpendicular front porch period FP′″ is equivalent to, for example, a period from the start time of the perpendicular front porch period FP′ to the time that the touch detection operation performed at the time of receiving a RAMWR command is completed (in other words, the touch detection period T ends).

After frame period F3, the display device DSP transitions to frame period F4 for performing display operation for displaying image C. In frame period F4, the display device DSP is driven in the normal drive mode.

In the above explanation, a RAMWR command is received in the perpendicular front porch period FP′ of frame period F3 in the low-speed drive mode. However, for example, when a RAMWR command is received in the display period DIS(B) of frame period F3, frame period F3 is terminated after the end of the display period of frame period F3 and the completion of the touch detection operation performed at the time of the end of the display period.

Thus, in the first modification, the display device DSP is capable of shortening the perpendicular front porch period FP′ after the display period DIS and the touch detection period T and transitioning to the next frame period. Further, the display device DSP is capable of switching (returning) the low-speed drive mode to the normal drive mode.

As described above, low-speed driving is realized by setting the length of display periods and touch detection periods so as to be equal to that of the normal drive mode and extending a perpendicular front porch period FP. In addition to this configuration, low-speed driving may be realized by, for example, extending a horizontal front porch period or a horizontal back porch period, extending a period in which pixel signals are written to a line, or decreasing the frequency of the source oscillator (internal oscillator 106) (a second modification).

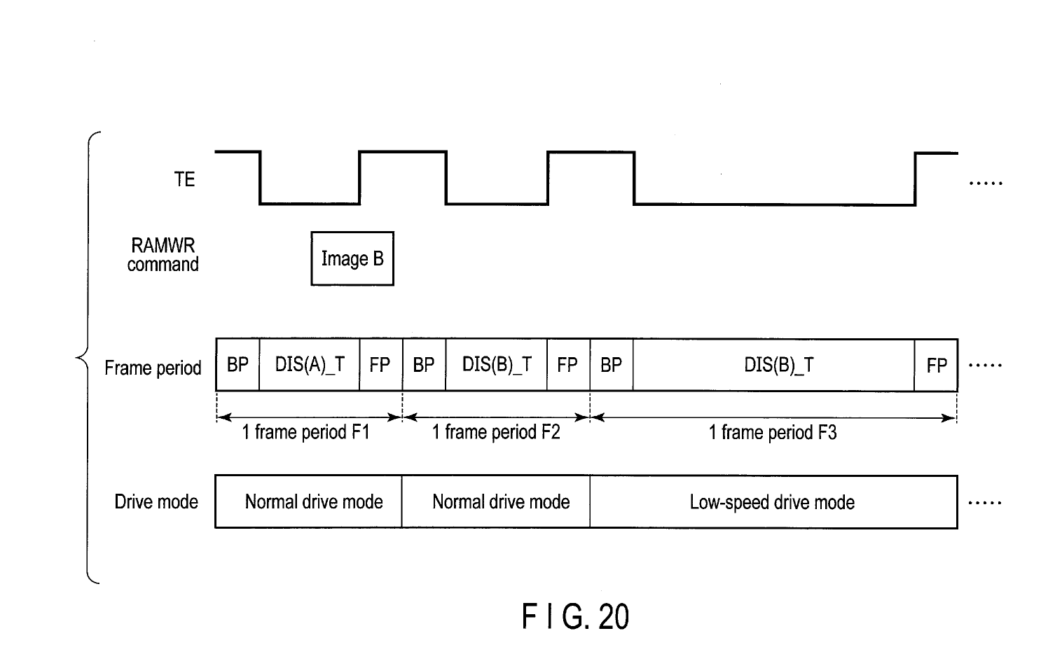

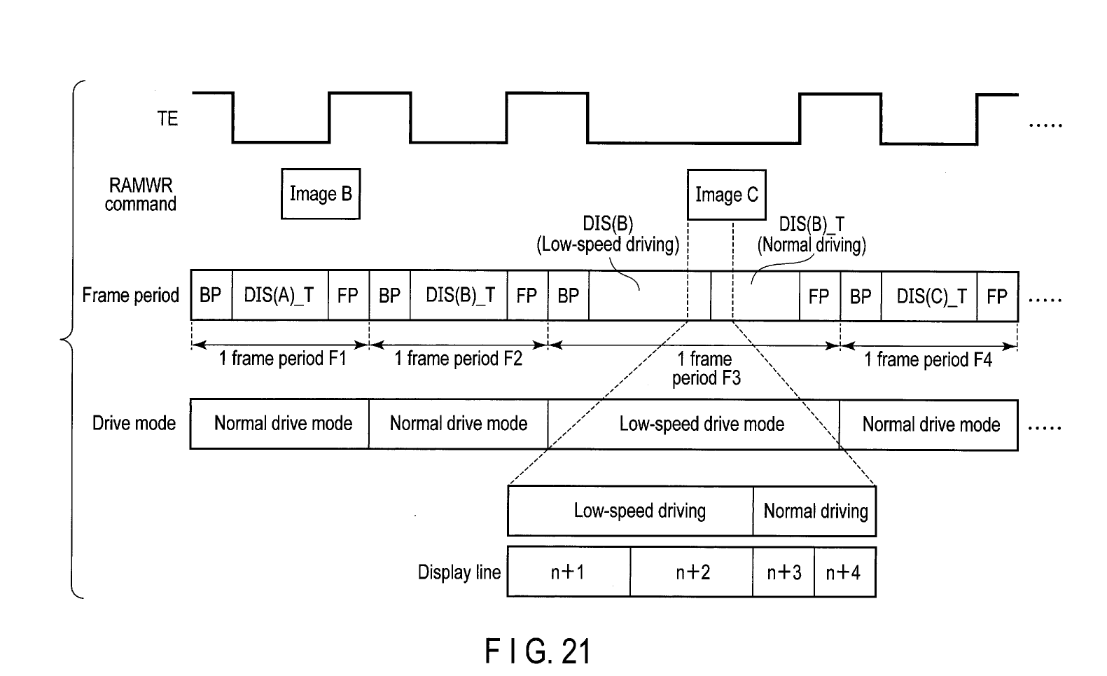

In this second modification, for example, as shown in FIG. 20, the scanning period DIS(B)_T of frame period F3 in the low-speed drive mode is lengthened. Here, this specification assumes that a RAMWR command is received in the scanning period in the low-speed drive mode in the second modification. In this case, the perpendicular front porch period of frame period F3 is short. Thus, as explained in the present embodiment, it is difficult to shorten frame period F3 by terminating the perpendicular front porch period in the middle. In this case, as shown in FIG. 21, frame period F3 is shortened by switching the low-speed drive mode to the normal drive mode in the middle of the scanning period of frame period F3 in the low-speed drive mode. Specifically, when a RAMWR command is received in the scanning period in the low-speed drive mode, for example, display operation is applied (in other words, pixel data is written) in the low-speed drive mode to the n+1^{th} and n+2^{th} display lines immediately after the reception of the RAMWR command, and display operation is applied in normal driving to the n+3^{th} and subsequent display lines. Although omitted in FIG. 21, touch detection operation is switched from the low-speed drive mode to the normal drive mode in the same manner.

When the low-speed drive mode is switched to the normal drive mode in the middle of a frame period in the above manner, the n+3^{th} and subsequent display periods (and touch detection periods) can be shortened. As a result, frame period F3 can be shortened. After the end of frame period F3, the display device DSP transitions to frame period F4 in normal driving.

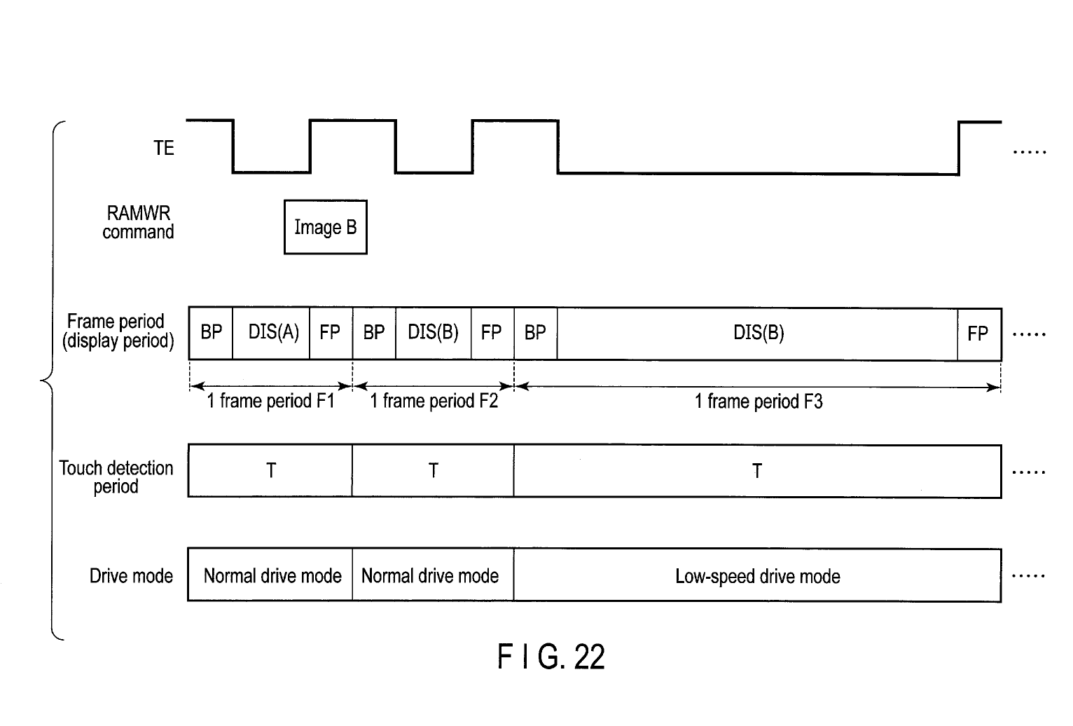

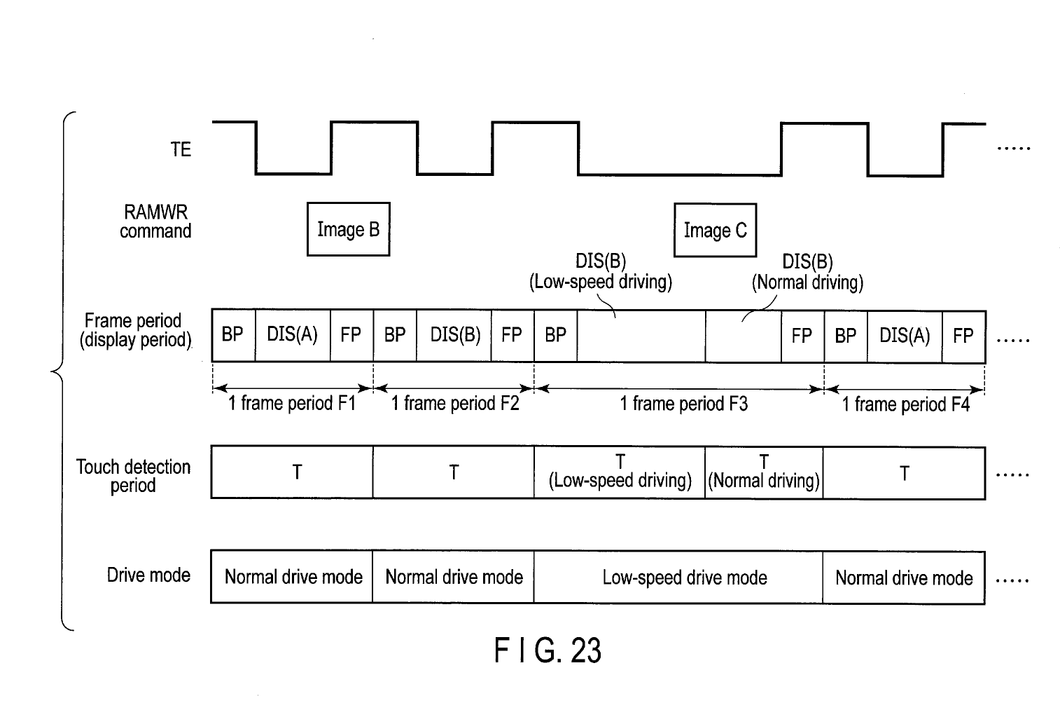

Although detailed explanation is omitted, as shown in FIG. 22 and FIG. 23, frame period F3 can be shortened even when the first modification (in which display operation and touch detection operation are independently performed) is combined with the second modification.

The display device DSP (the display device including a touch detection function) of the present embodiment may be incorporated into various electronic devices. The electronic devices into which the display device DSP is incorporated include, for example, television devices, digital cameras, video cameras, notebook computers, tablet computers, smartphones (mobile phones) and in-vehicle displays. The display device DSP of the present embodiment may be incorporated into electronic devices displaying an image (video) in various fields.

### Second Embodiment

Now, this specification explains a second embodiment. The display device of the present embodiment does not include a touch detection function. In this respect, the display device of the present embodiment is different from that of the first embodiment. In the following explanation, the display device of the present embodiment is an organic electroluminescent display device.

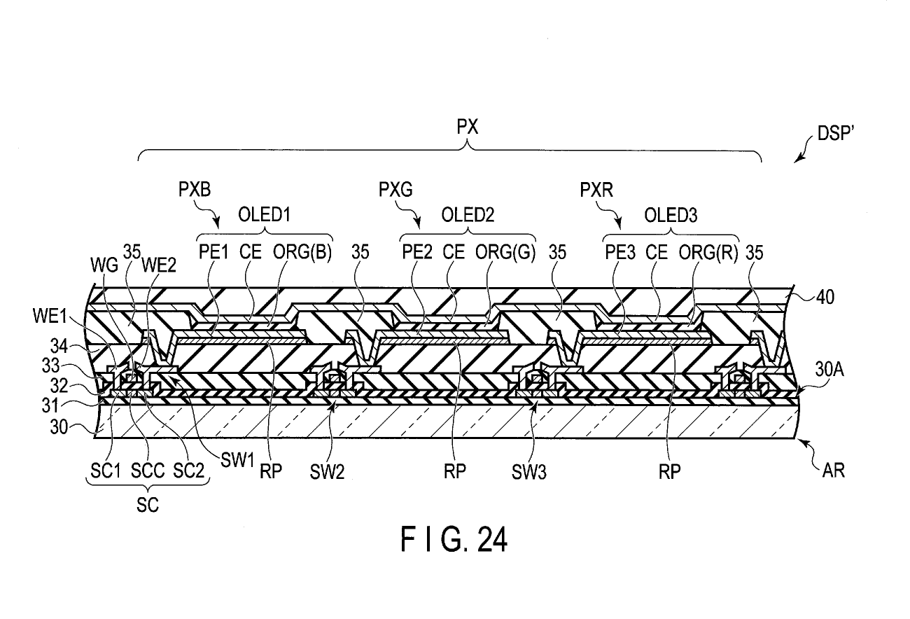

FIG. 24 is a drawing (cross-sectional view) schematically showing an example of the cross-sectional structure of a display device DSP′ (organic electroluminescent display device) according to the present embodiment. As shown in FIG. 24, an array substrate AR is formed by using a first insulating substrate 30. The first insulating substrate 30 may be either a glass substrate or a resinous substrate. The resinous substrate is formed of a resinous material such as polyimide, polyethylene terephthalate, polyethylene naphthalate, polycarbonate or polyether sulfone.

The array substrate AR includes, on the first main surface 30A side of the first insulating substrate 30, a first insulating film 31, a second insulating film 32, a third insulating film 33, a fourth insulating film 34, a bank 35, switching elements SW1 to SW3, a reflective plate RP, organic electroluminescent elements OLED1 to OLED3, a sealing film 40.

The first main surface 30A of the first insulating substrate 30 is covered with the first insulating film 31. The first insulating film 31 is formed of an inorganic material such as silicon nitride (SiN), silicon oxide (SiO) or silicon oxynitride (SiON), and has a single-layer structure or a stacked structure. Switching elements SW1 to SW3 are formed on the first insulating film 31. Switching element SW1 is provided in a blue pixel PXB. Switching element SW2 is provided in a green pixel PXG. Switching element SW3 is provided in a red pixel PXR. Each of switching elements SW1 to SW3 is, for example, a thin-film transistor (TFT) including a semiconductor layer SC. Switching elements SW1 to SW3 have the same structure. Here, the structure of switching element SW1 is specifically explained as a representative example. In the example shown in FIG. 24, switching element SW1 is a top-gate switching element, and includes the semiconductor layer SC formed of polycrystalline silicon (p-Si). The semiconductor layer SC may be formed of amorphous silicon (a-Si), an oxide semiconductor, etc. Switching element SW1 may be a bottom-gate switching element. It should be noted that a top-gate thin-film transistor applied as a switching element can reduce parasitic capacitance in comparison with a bottom-gate thin-film transistor.

The semiconductor layer SC includes a channel region SCC, and first and second impurity regions SC1 and SC2 containing more impurities than the channel region SCC. The channel region SCC is located between the first impurity region SC1 and the second impurity region SC2. The channel region SCC is equivalent to a region having a resistance higher than that of the first and second impurity regions SC1 and SC2. The semiconductor layer SC is formed on the first insulating film 31, and is covered with the second insulating film 32. The second insulating film 32 is provided on the first insulating film 31. The second insulating film 32 is formed of an inorganic material such as silicon oxide.

The gate electrode WG of switching element SW1 is formed on the second insulating film 32, and is located directly above the channel region SCC. The gate electrode WG is formed of a metal material such as molybdenum (Mo), tungsten (W), aluminum (Al), titanium (Ti) or copper (Cu), alloy containing these metal materials, etc. For example, the gate electrode WG is formed of molybdenum-tungsten (MoW). The gate electrode WG is covered with the third insulating film 33. The third insulating film 33 is provided on the second insulating film 32. The third insulating film 33 is formed of an inorganic material such as silicon nitride or silicon oxide.

Switching element SW1 includes first and second electrodes WE1 and WE2 formed on the third insulating film 33. The first electrode WE1 is electrically connected to the first impurity region SC1 of the semiconductor layer SC. The second electrode WE2 is electrically connected to the second impurity region SC2 of the semiconductor layer SC. The first and second electrodes WE1 and WE2 are formed of a metal material such as molybdenum (Mo), tungsten (W), aluminum (Al), titanium (Ti) or copper (Cu), alloy containing these metal materials, etc. For example, the first and second electrodes WE1 and WE2 are formed as a stacked structure of aluminum and titanium. The first and second electrodes WE1 and WE2 are covered with the fourth insulating film 34. The fourth insulating film 34 is provided on the third insulating film 33. The fourth insulating film 34 is formed of, for example, a resinous material such as acrylate resin.

Organic electroluminescent elements OLED1 to OLED3 are formed on the fourth insulating film 34. Organic electroluminescent element OLED1 is provided in the blue pixel PXB, and is electrically connected to switching element SW1. Organic electroluminescent element OLED2 is provided in the green pixel PXG, and is electrically connected to switching element SE2. Organic electroluminescent element OLED3 is provided in the red pixel PXR, and is electrically connected to switching element SW3. Organic electroluminescent elements OLED1 to OLED3 are top-emission self-luminous elements which emit light to the sealing film 40 side. For example, organic electroluminescent elements OLED1 to OLED3 emit light in different colors.

The bank 35 is formed on the fourth insulating film 34 and defines organic electroluminescent elements OLED1 to OLED3. Although the detailed description is omitted, the bank 35 has, for example, a lattice shape or a stripe shape on the fourth insulating film 34.

Organic electroluminescent element OLED1 includes a pixel electrode PE1, a common electrode CE facing pixel electrode PE1, and an organic light-emitting layer ORG(B) provided between pixel electrode PE1 and the common electrode CE. Organic electroluminescent element OLED2 includes a pixel electrode PE2, a common electrode CE facing pixel electrode PE2, and an organic light-emitting layer ORG(G) provided between pixel electrode PE2 and the common electrode CE. Organic electroluminescent element OLED3 includes a pixel electrode PE3, a common electrode CE facing pixel electrode PE3, and an organic light-emitting layer ORG(R) provided between pixel electrode PE3 and the common electrode CE.

Pixel electrode PE1 is electrically connected to switching element SW1. Pixel electrode PE2 is electrically connected to switching element SW2. Pixel electrode PE3 is electrically connected to switching element SW3. The edges of each of pixel electrodes PE1 to PE3 are covered with the bank 35. Pixel electrodes PE1 to PE3 are formed of, for example, a transparent conductive material such as indium tin oxide (ITO) or indium zinc oxide (IZO).

The reflective plate RP is provided between the first insulating substrate 30 and pixel electrodes PE1 to PE3. In the example shown in FIG. 24, the reflective plate RP is formed on the fourth insulating film 34, and overlaps pixel electrodes PE1 to PE3. The reflective plate PR is formed of, for example, a high-reflective metal material such as aluminum (Al), magnesium (Mg), silver (Ag) or titanium (Ti). The reflective plate RP may be provided at any position between the first insulating substrate 30 and pixel electrodes PE1 to PE3. However, to prevent misoperation of switching elements SW1 to SW3 caused when the light emitted from organic electroluminescent elements OLED1 to OLED3 reaches switching elements SW1 to SW3, the reflective plate RP is preferably close to pixel electrodes PE1 to PE3 and covers switching elements SW1 to SW3.

Organic light-emitting layer ORG(B) contains a dopant material which emits blue light. Organic light-emitting layer ORG(G) contains a dopant material which emits green light. Organic light-emitting layer ORG(R) contains a dopant material which emits red light. Each of organic light-emitting layers ORG(B), ORG(G) and ORG(R) is cut on the bank 35.

The common electrode CE is continuously formed over organic electroluminescent elements OLED1 to OLED3, and also covers the bank 35 exposed from the organic light-emitting layers. The common electrode CE is formed of, for example, a transparent conductive material such as ITO or IZO. The common electrode CE may be formed as a semi-transmissive film formed of magnesium (Mg), silver (Ag), etc.

In organic electroluminescent elements OLED1 to OLED3, for example, a hole injection layer and a hole transport layer may be interposed between pixel electrodes PE1 to PE3 and organic light-emitting layers ORG(B), ORG(G) and ORG(R). For example, an electron injection layer and an electron transport layer may be interposed between organic light-emitting layers ORG(B), ORG(G) and ORG(R) and the common electrode CE.

The sealing film 40 seals organic electroluminescent elements OLED1 to OLED3. The sealing film 40 protects organic electroluminescent elements OLED1 to OLED3 against fluid, oxygen, etc. For example, the sealing film 40 is formed as a stacked structure in which an inorganic thin film formed of an inorganic material and an organic thin film formed of an organic material are alternately stacked.

In the display device DSP′, organic electroluminescent elements OLED1 to OLED3 emit light to outside via the sealing film 40. In the blue pixel PXB, blue light is emitted from organic electroluminescent element OLED1. In the green pixel PXG, green light is emitted from organic electroluminescent element OLED2. In the red pixel PXR, red light is emitted from organic electroluminescent element OLED3. In this way, color display is realized.

The array substrate AR is not limited to the above structural example. For example, when the pixels PX of the display device DSP′ further include white pixels as subpixels, each white pixel may include an organic electroluminescent element including an organic layer which emits white light or include the three types of organic electroluminescent elements OLED1 to OLED3.

An organic light-emitting layer which is continuously formed over organic electroluminescent elements OLED1 to OLED3 and emits white light may be applied to the array substrate AR. Color display can be realized by combining color filters facing organic electroluminescent elements OLED1 to OLED3 with the array substrate AR.

In the display device DSP (including a touch detection function) of the first embodiment, as explained in FIG. 12 to FIG. 14, when a RAMWR command is received in a frame period in the low-speed drive mode, the display device DSP is capable of shortening the frame period (specifically, the perpendicular front porch period included in the frame period), transitioning to the next frame period and switching the low-speed drive mode to the normal drive mode.

The above operation of the display device DSP of the first embodiment is also applicable to the display device DSP′ of the present embodiment. Specifically, although each scanning period DIS T explained in FIG. 12 to FIG. 14 is a period in which display operation and touch detection operation are repeatedly performed, in the display device DSP′ of the present embodiment, touch detection operation is not performed. Thus, the scanning periods are periods (display periods) in which display operation is performed. In the present embodiment, the scanning periods shown in FIG. 12 to FIG. 14 are replaced by display periods. In the other respects, the operation of the present embodiment is the same as that of the first embodiment. Thus, in the present embodiment, when a RAMWR command is received in a frame period in the low-speed drive mode, the display device DSP′ is capable of shortening the frame period (specifically, the perpendicular front porch period included in the frame period) and switching the low-speed drive mode to the normal drive mode.

The above operation of the display device DSP′ is controlled by a panel driver (not shown) mounted on the display device DSP′. This control is the same as that of the first embodiment, detailed description thereof being omitted.

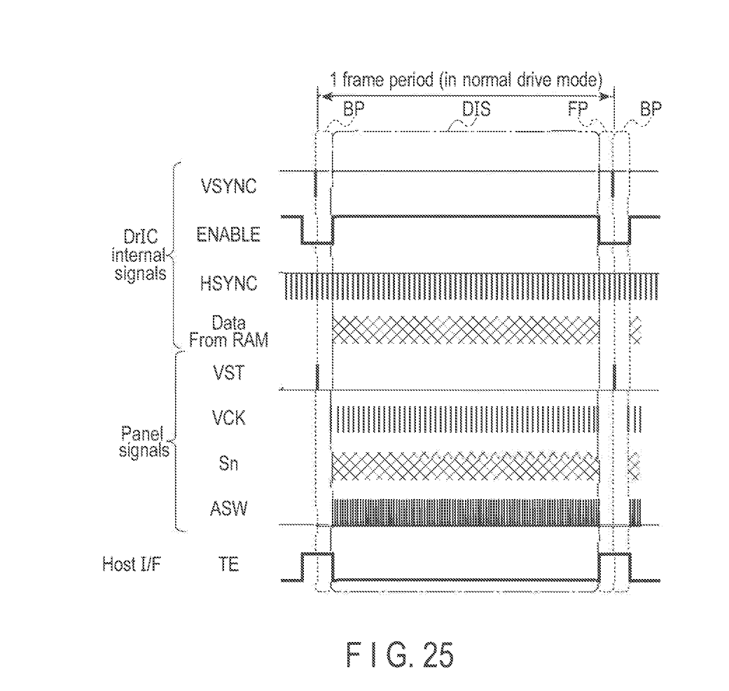

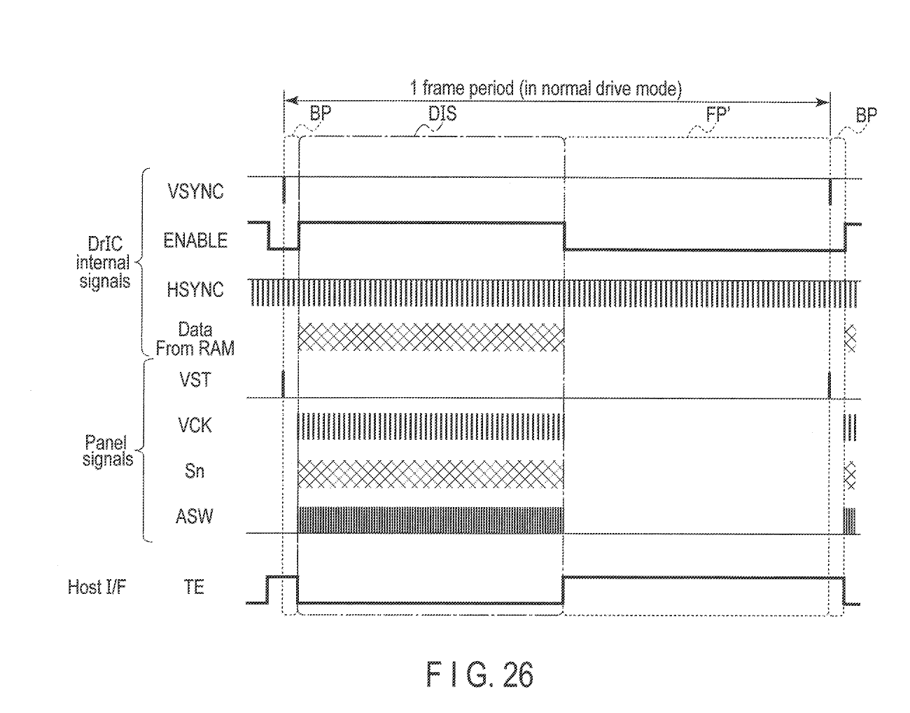

FIG. 25 and FIG. 26 are timing charts showing the relationship of various signals in each frame period in the normal drive mode and the low-speed drive mode according to the present embodiment. In FIG. 25 and FIG. 26, the signals related to each touch detection period T and touch detection operation are not shown. In the other respects, FIG. 25 and FIG. 26 are the same as FIG. 15 and FIG. 16. Thus, detailed description of the figures is omitted here.

As described above, the operation of the display device DSP (including a touch detection function) of the first embodiment is applied to the display device DSP′ which does not include a touch detection function (for example, an organic electroluminescent display device). In this way, when a RAMWR command (switch signal) is received, the display device DSP′ is capable of shortening the frame period in the low-speed drive mode, transitioning to the next frame period and switching the drive state from the low-speed drive mode to the normal drive mode. In this configuration, the drive state of the display device DSP′ can be appropriately switched in accordance with a switch signal such as a RAMWR command. Thus, the display device DSP′ is capable of promptly returning from low-speed driving to normal driving.

In the present embodiment, the display device DSP′ is explained as an organic electroluminescent display device. However, the display device DSP′ may be realized as, for example, a liquid crystal display device which does not include a touch detection function. When the display device DSP′ is a liquid crystal display device which does not include a touch detection function, for example, the touch detection electrodes Rx shown in FIG. 1 may not be provided.

According to at least one of the above embodiments, it is possible to provide a display device and a method capable of appropriately switching the drive state.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device driven in a first drive mode for displaying images of a frame in a first frame period and a second drive mode for displaying images of a frame in a second frame period longer than the first frame period, the display device comprising:
a display panel configured to perform display operation for displaying an image based on a pixel signal; and
a driver configured to switch a drive mode between the first drive mode and the second drive mode by controlling the display operation, wherein
when a switch signal for switching the second drive mode to the first drive mode is received while the display device is driven in the second drive mode, the driver is configured to shorten the second frame period and switch the second drive mode to the first drive mode.

2. The display device of claim 1, wherein
the second frame period comprises a display period in which the display operation is performed, and a display adjustment period for adjusting display of the image, and
the driver is configured to:
determine whether the display period in the second frame period ends when the switch signal is received,
terminate the second frame period in a middle of the display adjustment period and switch the second drive mode to the first drive mode, when it is determined that the display period ends, and
terminate the second frame period after an end of the display period and switch the second drive mode to the first drive mode, when it is determined that the display period does not end.

3. The display device of claim 1, wherein
the first frame period comprises a display period in which the display operation is performed, and a display adjustment period for adjusting display of the image,
a length of the display period in the second frame period is equal to a length of the display period in the first frame period, and
the display adjustment period in the second frame period is longer than the display adjustment period in the first frame period.

4. The display device of claim 3, wherein
the display adjustment period comprises a perpendicular back porch period in which a polarity of display of the image is inverted, and a perpendicular front porch period provided after the display period, and
when the display device is driven in the second drive mode, the front porch period is extended.

5. The display device of claim 1, further comprising a memory to which pixel data is written from outside, wherein
the display panel is configured to perform display operation based on a pixel signal generated from the pixel data written to the memory, and
the switch signal comprises a signal indicating that the pixel data is written to the memory.

6. The display device of claim 5, wherein
when the display device is driven in the first drive mode, and further when the pixel data is not written to the memory in a predetermined time, the driver is configured to switch the first drive mode to the second drive mode.

7. The display device of claim 1, further comprising a detector configured to perform touch detection operation for detecting a detection signal based on a change in capacitance for an external close object, wherein
the second frame period comprises a display period in which the display operation is performed, a touch detection period in which the touch detection operation is performed, and a display adjustment period for adjusting display of the image,
the driver is configured to determine whether the display period and the touch detection period in the second frame period end when the switch signal is received,
the driver is configured to:
terminate the second frame period in a middle of the display adjustment period and switch the second drive mode to the first drive mode, when it is determined that the display period and the touch detection period end, and
terminate the second frame period after an end of the display period and the touch detection period and switch the second drive mode to the first drive mode, when it is determined that the display period or the touch detection period does not end.

8. The display device of claim 7, wherein
the display panel comprises a plurality of common electrodes to which display drive voltage is applied in the display period,
the detector comprises a plurality of drive electrodes to which touch drive voltage is applied in the touch detection period,
the common electrodes are used as the drive electrodes, and
the display period does not overlap the touch detection period.

9. The display device of claim 1, wherein
the driver comprises:
a counter circuit configured to count elapse of each frame period; and
a reset circuit configured to reset a count of the counter circuit when the second frame period is shortened and the second drive mode is switched to the first drive mode.

10. A method for driving a display device in a first drive mode for displaying images of a frame in a first frame period and a second drive mode for displaying images of a frame in a second frame period longer than the first frame period, the method comprising:
performing display operation for displaying an image based on a pixel signal; and
switching a drive mode between the first drive mode and the second drive mode by controlling the display operation, wherein
the switching comprises shortening the second frame period and switching the second drive mode to the first drive mode when a switch signal for switching the second drive mode to the first drive mode is received while the display device is driven in the second drive mode.

11. The method of claim 10, wherein
the second frame period comprises a display period in which the display operation is performed, and a display adjustment period for adjusting display of the image, and
the switching comprises
determining whether the display period in the second frame period ends when the switch signal is received,
terminating the second frame period in a middle of the display adjustment period and switching the second drive mode to the first drive mode, when it is determined that the display period ends, and
terminating the second frame period after an end of the display period and switching the second drive mode to the first drive mode, when it is determined that the display period does not end.

12. The method of claim 10, wherein
the first frame period comprises a display period in which the display operation is performed, and a display adjustment period for adjusting display of the image,
a length of the display period in the second frame period is equal to a length of the display period in the first frame period, and
the display adjustment period in the second frame period is longer than the display adjustment period in the first frame period.

13. The method of claim 12, wherein
the display adjustment period comprises a perpendicular back porch period for determining a polarity of display of the image, and a perpendicular front porch period provided after the display period, and
the perpendicular front porch period is extended when the display device is driven in the second drive mode.

14. The method of claim 10, wherein
the display device comprises a memory to which pixel data is written from outside,
the performing display operation comprises performing display operation based on a pixel signal generated from the pixel data written to the memory, and
the switch signal comprises a signal indicating that the pixel data is written to the memory.

15. The method of claim 14, wherein the switching comprises switching the first drive mode to the second drive mode when the display device is driven in the first drive mode and further when the pixel data is not written to the memory in a predetermined time.

16. The method of claim 10, further comprising performing touch detection operation for detecting a detection signal based on a change in capacitance for an external close object, wherein
the second frame period comprises a display period in which the display operation is performed, a touch detection period in which the touch detection operation is performed, and a display adjustment period for adjusting display of the image, and
the switching comprises
determining whether the display period and the touch detection period in the second frame period end when the switch signal is received,
terminating the second frame period in a middle of the display adjustment period and switching the second drive mode to the first drive mode, when it is determined that the display period and the touch detection period end, and
terminating the second frame period after an end of the display period and the touch detection period and switching the second drive mode to the first drive mode, when it is determined that the display period or the touch detection period does not end.

17. The display control method of claim 16, wherein
a plurality of common electrodes to which display drive voltage is applied in the display period are used as a plurality of drive electrodes to which touch drive voltage is applied in the touch detection period, and
the display period does not overlap the touch detection period.

18. The display control method of claim 10, wherein
the display device comprises a counter circuit and a reset circuit, and
the switching comprises
counting elapse of each frame period by the counter circuit, and
resetting a count of the counter circuit by the reset circuit when the second drive mode is switched to the first drive mode.
